(19) United States
(12) Patent Application Publication
(10) Pub. No.: US 2026/0317066 A1
(43) Pub. Date: Oct. 15, 2026

(54) WAREHOUSING SYSTEM FOR STORING AND RETRIEVING GOODS IN CONTAINERS

(71) Applicant: Symbotic LLC, Wilmington, MA (US)

(72) Inventors: Marc DUCHARME, Boucherville (CA); Edward A. MACDONALD, Somerville, MA (US); Patrick DONAGHEY, Wilmington, MA (US); Thomas PERRY, Townsend, MA (US); Régis MÉTIVIER, Terrebonne (CA)

(21) Appl. No.: 19/643,433

(22) Filed: Apr. 9, 2026

Related U.S. Application Data
(60) Provisional application No. 63/786,491, filed on Apr. 10, 2025.

(51) Int. Cl. B65G 1/137; B65G 1/06

(52) U.S. Cl. CPC B65G 1/1376; B65G 1/065

(57) ABSTRACT

A retail store order fill station includes order fill load ports, each of which has a different respective load opening facing a deck, where robots autonomously traverse the deck so as to form inbound and outbound lanes along which the robots respectively arrive to and depart from each load opening. A side having a container input interface configured for communicating with an infeed conveyor in feeding a storage container to the retail order fill station. The container input interface is configured so that a picker of at least one good, picked from the storage container addresses the respective load opening of each order fill load port with substantially one step. Each respective load opening has at least a corresponding outbound lane, and the load opening is sized and shaped so that the picker accesses the robots, through the load opening, disposed on and aligned with the corresponding outbound lane.

### CROSS-REFERENCE TO RELATED APPLICATIONS

This application is a non-provisional of, and claims the benefit of, United States provisional patent application number 63/786,491 filed on Apr. 10, 2025, the disclosure of which is incorporated herein by reference in its entirety.

### BACKGROUND

### 1. Field

The present disclosure generally relates to material handling systems, and more particularly, to transport and picking of items within the material handling system.

### 2. Brief Description of Related Developments

Generally picking systems for articles include a conveyance from which an article is picked and another conveyance to which the picked article is placed. These conveyances may be in the form of containers transported along a conveyor or carried by an autonomous vehicle. Where the containers are transported along conveyors for presentation to a picker at a pick station, there are generally more than one conveyors that transport and remove the containers to and from a pick station. These conveyors, transporting containers to and from the pick station, are arranged side-by-side forming general U-shaped conveyor paths and occupy large amounts of facility floor space.

Where the containers are transported by automated vehicles for presentation to a picker at a pick station, the automated vehicles travel along paths are also generally U-shaped. The U-shaped paths may be formed by travel surfaces that lie in the same horizontal plane or by elevator systems that move the automated vehicles between travel surfaces located in different vertical planes. The automated vehicle conveyance is generally complex and costly.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of an automated storage and retrieval system in accordance with the present disclosure;

FIG. 1A is a schematic illustration of a portion of the automated storage and retrieval system of FIG. 1 in accordance with the present disclosure;

FIG. 1B is a schematic illustration of a portion of the automated storage and retrieval system of FIG. 1 in accordance with the present disclosure;

FIG. 2 is a schematic plan illustration of a tandem pick station of the automated storage and retrieval system of FIG. 1 in accordance with the present disclosure;

FIG. 3 is a schematic perspective illustration of the tandem pick station of FIG. 2 in accordance with the present disclosure;

FIG. 4 is a schematic side illustration of the tandem pick station of FIG. 2 in accordance with the present disclosure;

FIG. 5 is a schematic plan illustration of a portion of the tandem pick station of FIG. 2 in accordance with the present disclosure;

FIG. 6 is a schematic perspective illustration of a portion of the tandem pick station of FIG. 2 in accordance with the present disclosure;

FIG. 7 is a flow diagram of an exemplary method in accordance with the present disclosure;

FIG. 8A is a schematic perspective illustration of a portion of the tandem pick station of FIG. 2 in accordance with the present disclosure;

FIG. 8B is a schematic perspective illustration of a portion of the tandem pick station of FIG. 2 in accordance with the present disclosure;

FIG. 9A is a schematic top view illustration of a portion of the tandem pick station of FIG. 2 in accordance with the present disclosure;

FIG. 9B is a schematic top view illustration of a portion of the tandem pick station of FIG. 2 in accordance with the present disclosure;

FIG. 10 is a schematic illustration of a portion of the tandem pick station of FIG. 2 in accordance with the present disclosure; and

FIGS. 11, 12, and 13 are flow diagrams of exemplary methods in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

Spatial terms such as “left,” “right,” “top,” “bottom,” “upper,” “lower,” “front,” “back,” “vertical,” and “horizontal” as may be used herein are by way of example and illustration only are not meant to limit the description and may be exchanged in position and orientation.

The terms “substantially” and “about” as may be used herein refer to a feature that may be varied within an acceptable manufacturing tolerance for a given application.

As referred to herein, an “operator” may be a human operator or a robotic operator.

The terms “may,” “can,” and “configured to” (and similar terms) used in the context of controls, controllers, computer components, and/or programming thereof (e.g., including large language models, neural networks, and other forms of machine learning), such as, for example, in the expression a “controller may ...” or a “controller is configured to” indicates that such controllers, computer components, and/or programming thereof includes suitable non-transitory programming and/or hardware to perform or otherwise execute the functionality associated therewith.

All patents and publications (inclusive of patent publication and non-patent literature) cited in the present disclosure, if any, are herein incorporated by reference in their entireties, as if each individual patent or publication were specifically and individually indicated as being incorporated by reference. The dates of publication or issuance of any cited patents or publications may be different from the actual publication or issuance date and should be independently confirmed by the reader of this disclosure.

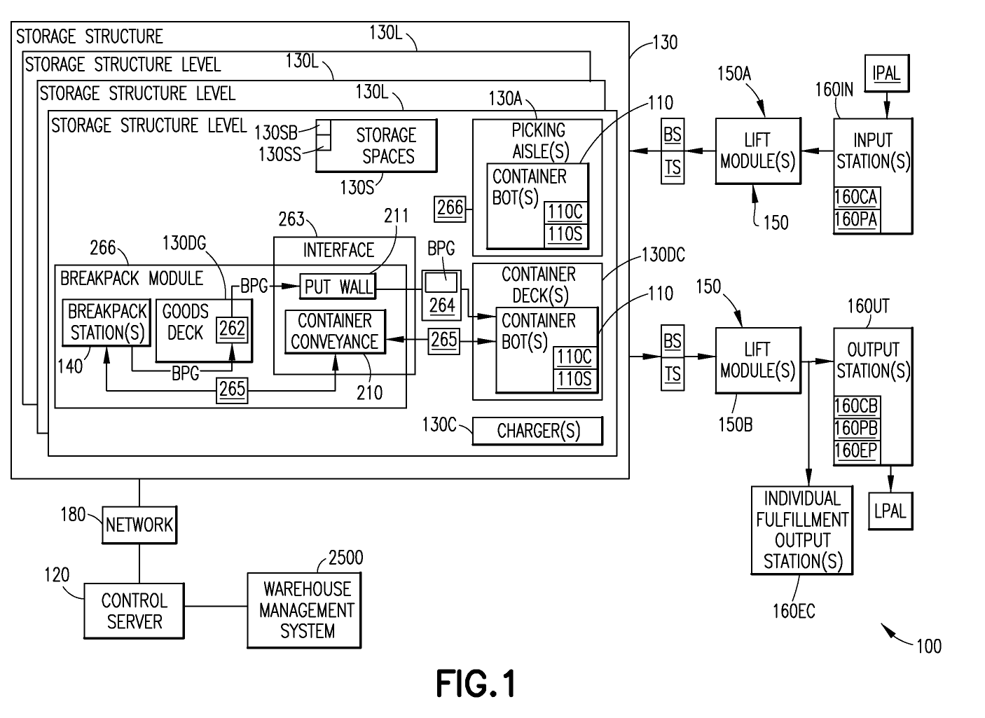

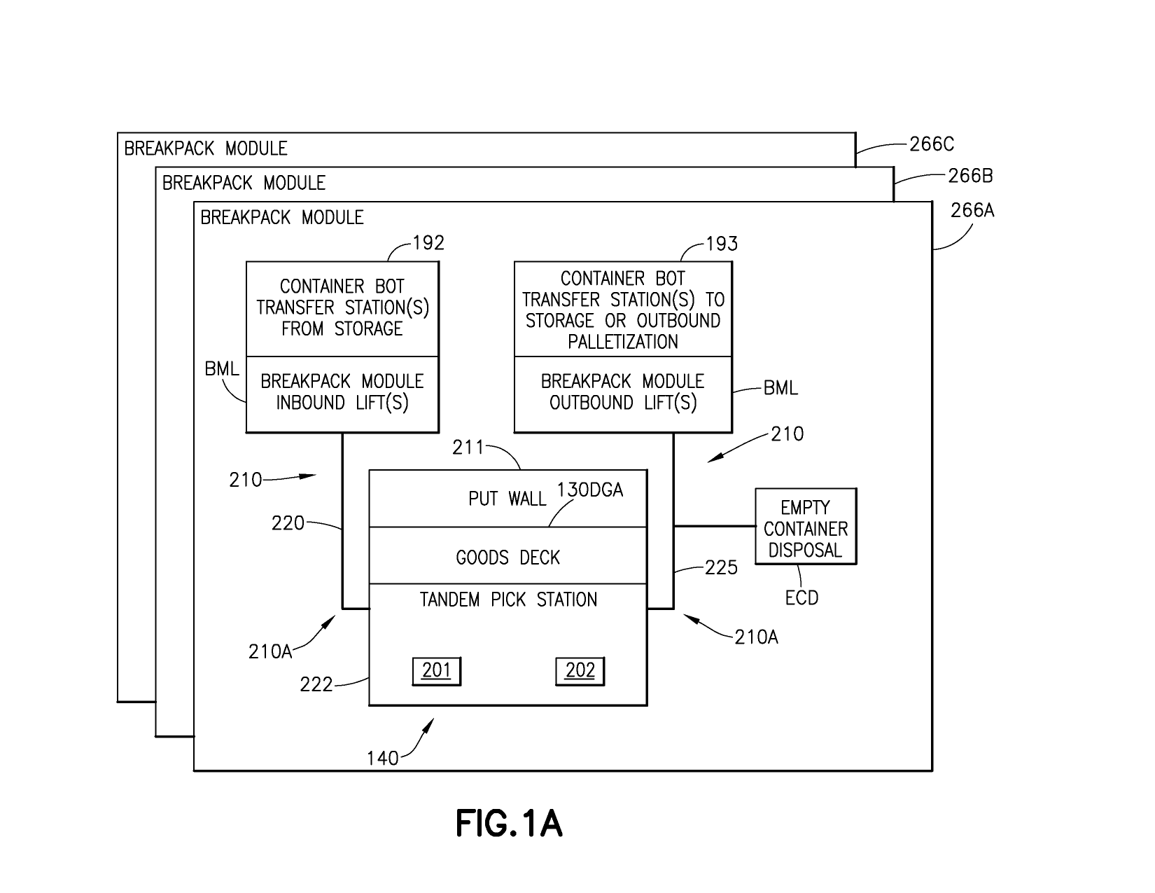

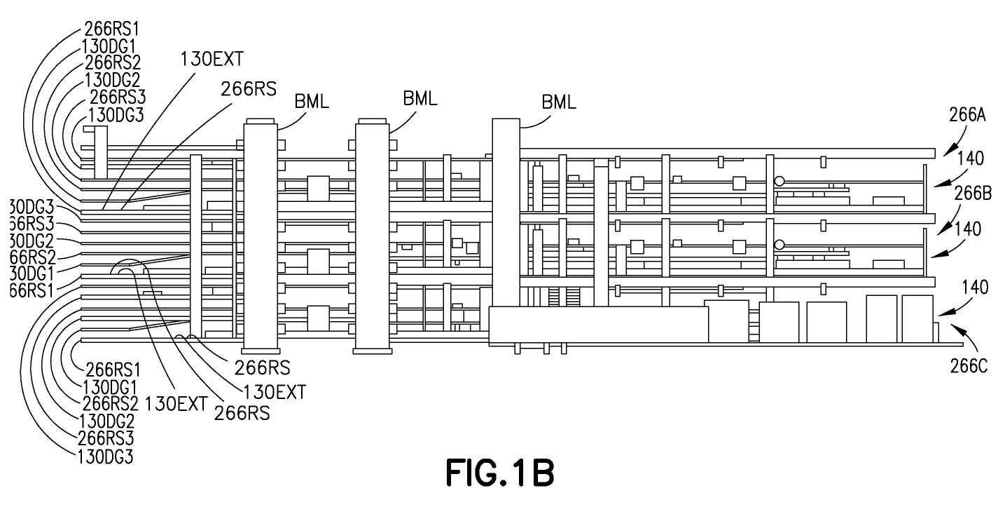

FIG. 1 is a schematic illustration of an automated storage and retrieval system (also referred to herein as a warehousing/warehouse system or product order fulfillment system) 100 in accordance with the present disclosure. Although the present disclosure will be described with reference to the drawings, it should be understood that the present disclosure can be embodied in many forms. In addition, any suitable size, shape or type of elements or materials could be used.

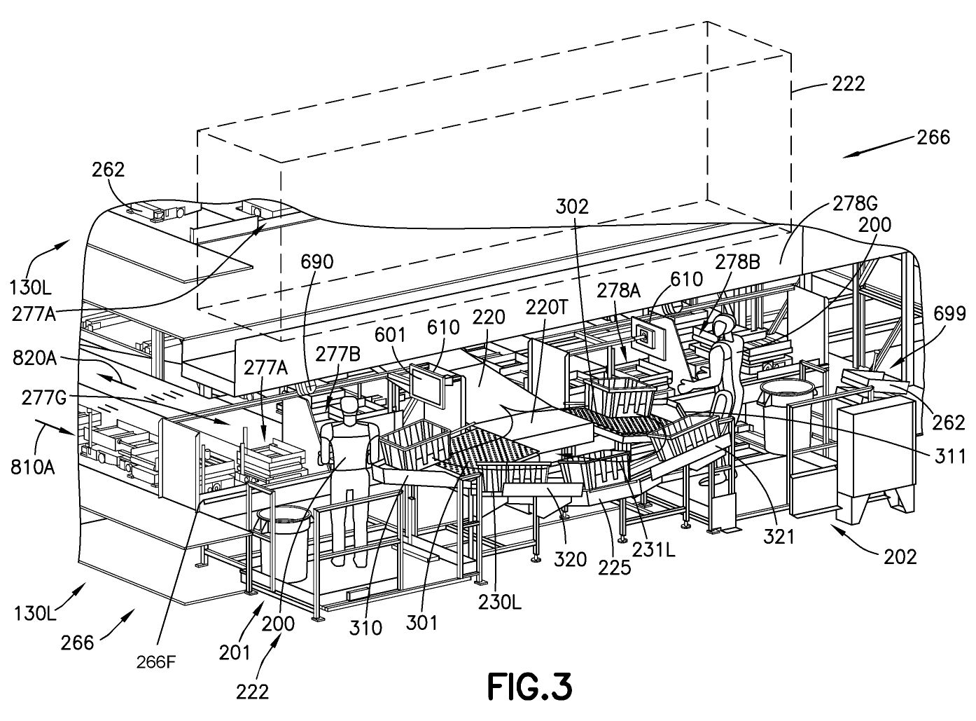

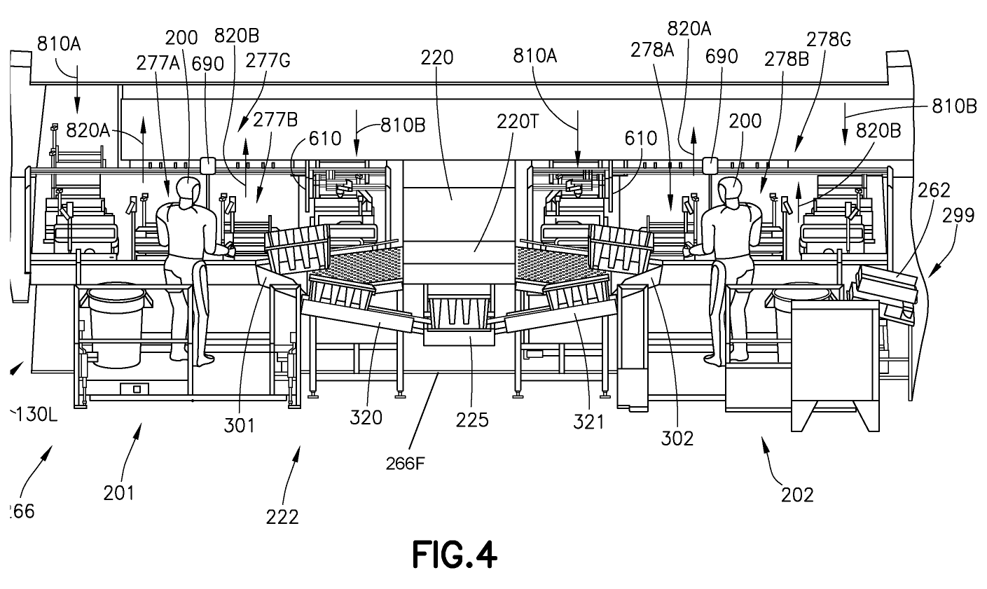

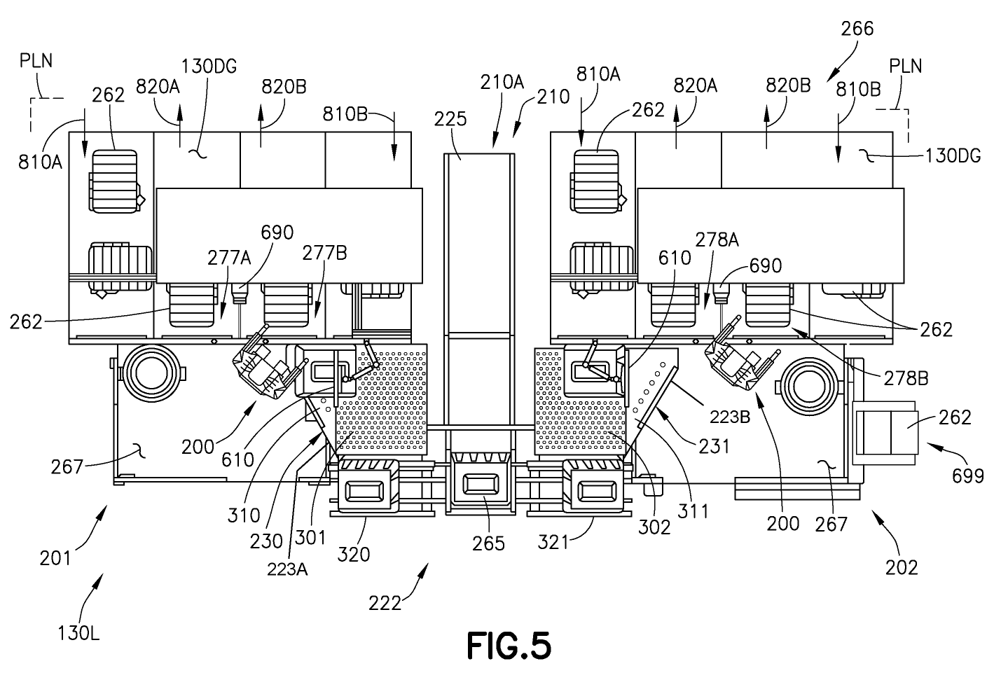

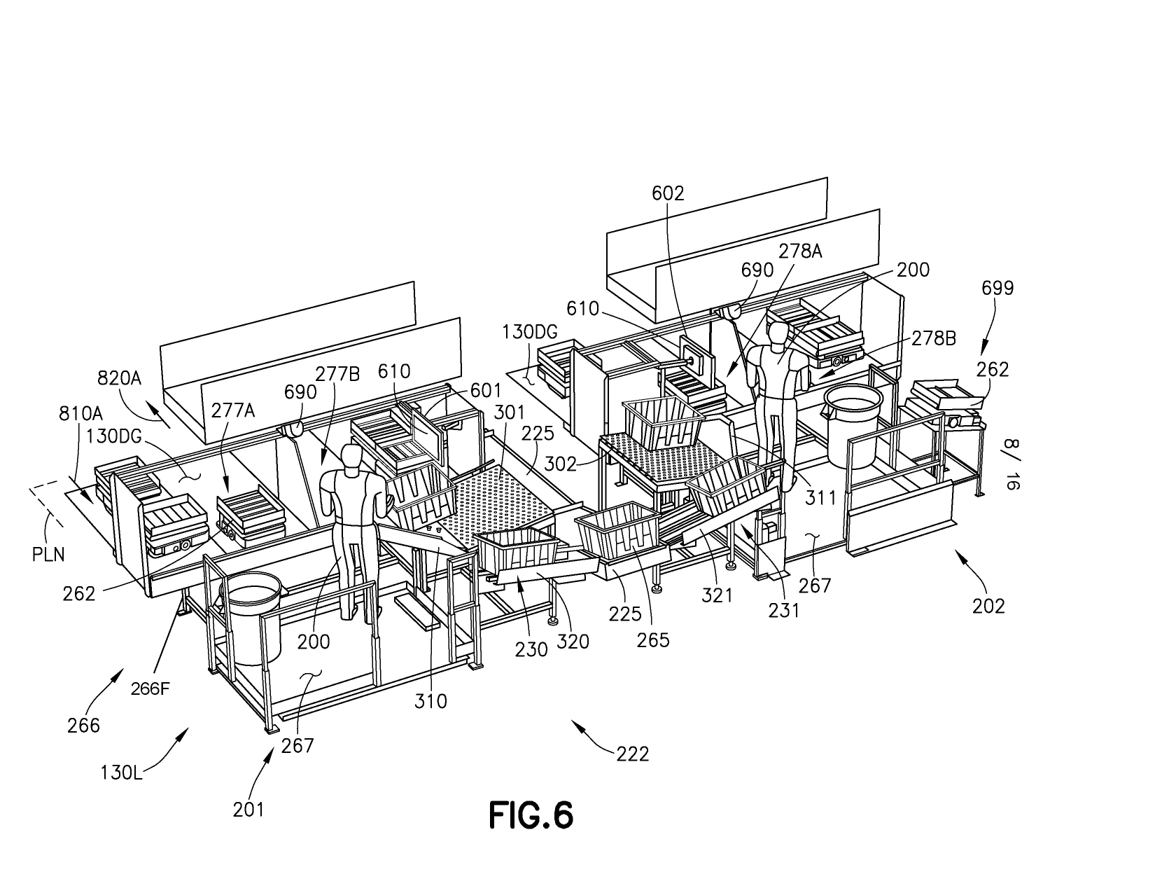

As described herein, with reference to FIGS. 1-6 and 8A-10, the present disclosure provides for one or more of a retail store order fill station 140 and a distribution center or breakpack transport system 266, the details of which are described herein.

The A retail store order fill station 140 is for removing at least one good from a storage container of a set of goods, and placement of the at least one good in an order (or breakpack goods) container 264. The retail store order fill station 140 may include one or more of the following: a frame 266F that forms more than one order fill load ports 277, 278, each of which has a different respective load opening 277A, 277B, 278A, 278B facing a deck 130DG of an asynchronous transport system (e.g., including at least the goods bots 262), where autonomous mobile robots 262 (also referred to as goods bots 262) autonomously traverse the deck 130DG so as to form an inbound lane 810A, 810B and an outbound lane 820A, 820B along which the autonomous mobile robots 262 respectively arrive to and depart from each load opening 277A, 277B, 278A, 278B, wherein the load opening 277A, 277B, 278A, 278B of each respective order fill load port 277, 278 is separate and distinct from each other order fill load port 277, 278; and a side 223A, 223B connected to the frame 266F, the side 223A, 223B being disposed at an angle with respect to the load opening 277A, 277B, 278A, 278B of each order fill load port 277, 278, and has a container input interface configured for communicating with an infeed synchronous transport system or conveyor 220 in feeding the storage container 265, with the set of goods BPG, to the retail order fill station 140, wherein the container input interface includes at least one of a movable bed 301, 302 and static platform 310, 311, posed adjacent the respective load opening of each order fill load port 277, 278 so that a picker 200 of the at least one good BPG, picked from the storage container 265 in fed via the container input interface addresses the respective load opening 277A, 277B, 278A, 278B of each order fill load port 277, 278 with substantially one step; and wherein each respective load opening 277A, 277B, 278A, 278B is arranged with respect to the deck 130DG so that each respective load opening 277A, 277B, 278A, 278B has at least a corresponding outbound lane 820A, 820B, and the load opening 277A, 277B, 278A, 278B is sized and shaped so that the picker 200 addressing the load opening 277A, 277B, 278A, 278B accesses the autonomous mobile robots 262, through the addressed load opening 277A, 277B, 278A, 278B, disposed on and aligned with the corresponding outbound lane 820A, 820B.

The retail store order fill station 140 may include one or more of the following, employed individually, in any combination thereof, and/or in any combination with the features described herein:
the one of the autonomous mobile robots 262 loaded with at least one good BPG is arranged so as to traverse the deck 130DG and transport the at least one ordered good BPG to an order container 264 separate and distinct from the storage container 265;
the loaded autonomous mobile robot 262 departs the respective load opening 277A, 277B, 278A, 278B through which the autonomous mobile robot 262 was loaded along the corresponding outbound lane 820A, 820B;
the corresponding outbound lane 820A, 820B and inbound lane 810A, 810B for the respective load opening 277A, 277B, 278A, 278B are on a common level;
the respective load opening 277A, 277B, 278A, 278B is sized and shaped so that the autonomous mobile robot(s) 262 disposed on the corresponding outbound lane 820A, 820B is/are accessed via the load opening 277A, 277B, 278A, 278B addressed by the picker 200;
the load opening 277A, 277B, 278A, 278B is arranged so as to complement access to the autonomous mobile bots through the load opening of at least one of a human and robot picker (generally referred to herein as picker 200).
a container output configured for communicating with an outfeed synchronous transport system or conveyor 225 to outfeed one or more of storage containers 265 holding a remaining set of goods not picked by the picker 200 and empty storage containers 265.
the movable bed 301, 302 comprises one or more of a belt conveyor, a gravity roller conveyor, a powered roller conveyor, a chain conveyor, and a ball transfer conveyor.
the at least one of the movable bed 301, 302 and static platform 310, 311 comprise an edge proximate the picker 200 and substantially level with a level of the deck 130DG.
an indication system configured to identify the addressed load opening 277A, 277B, 278A, 278B for a pick/place operation by the picker 200;
the order fill load ports 277, 278 are disposed adjacent one another so as to form a tandem pick station 222, where each pick station 201, 202 of the tandem pick station 222 includes respective load openings 277A, 277B, 278A, 278B, of the different respective load openings, disposed along a respective container travel loop 230L, 231L of the deck 130DG, and each pick station 201, 202 of the tandem pick station 222 forms a goods transfer interface to effect breakpack goods BPG transfer between the storage container 265 and autonomous mobile robot 262;
the infeed conveyor 220 and the outfeed conveyor 225 are stacked one above the other;
infeed conveyor 220 and the outfeed conveyor 225 form opposing conveyor sections, the opposing conveyor sections include: two divergent conveyor sections diverging from a common infeed conveyor section; and two convergent conveyor sections converging into a common outfeed conveyor section, each convergent conveyor section being coupled to a respective divergent conveyor section so as to form the respective container travel loop 230L, 231L with the common outfeed conveyor section and the common infeed conveyor section; and
indicia 9222A-9222D configured to provide the picker 200 goods transfer instructions for transferring one or more goods BPG from a container 265 on the infeed conveyor 220 to the autonomous mobile robot 262.

The distribution center or breakpack transport system 266 is for filling at least one ordered good BPG (also referred to herein as a breakpack good(s)). The distribution center or breakpack transport system 266 includes one of more of the following: an asynchronous transport system (e.g., including at least the goods bots 262) having a deck 130DG with autonomous mobile robots 262 (also referred to herein as goods bots) autonomously traversing the deck 130DG; a breakpack order fill station 140 connected to the deck 130DG, the station having: a frame 266F that forms more than one order fill load ports 277, 278, each of which has a different respective load opening 277A, 277B, 278A, 278B facing the deck 130DG of the asynchronous transport system, the autonomous mobile robots 262 traverse the deck 130DG so as to form an inbound lane 810A, 810B and an outbound lane 820A, 820B along which the autonomous mobile robots 262 respectively arrive to and depart from each load opening 277A, 277B, 278A, 278B, wherein the load opening 277A, 277B, 278A, 278B of each respective order fill load port 277, 278 is separate and distinct from each other order fill load port 277, 278; and a side 223A, 2223B connected to the frame 266F, the side 223A, 223B being disposed at an angle with respect to the load opening 277A, 277B, 278A, 278B of each order fill load port 277, 278, and has a container input interface configured for communicating with an infeed synchronous transport system or conveyor 220 in feeding a storage container 265, holding a set of goods BPG (also referred to herein as breakpack goods), to the breakpack order fill station 140, wherein the container input interface includes at least one of a movable bed 301, 302 and static platform 310, 311, posed adjacent the respective load opening 277A, 277B, 278A, 278B of each order fill load port 277, 278 so that a picker 200 of the at least one ordered good BPG, picked from the storage container 265 in fed via the container input interface addresses the respective load opening 277A, 277B, 278A, 278B of each order fill load port 277, 278 with substantially one step; and wherein each respective load opening 277A, 277B, 278A, 278B is arranged with respect to the deck 130DG so that each respective load opening 277A, 277B, 278A, 278B has at least a corresponding outbound lane 820A, 820B, and the load opening 277A, 277B, 278A, 278B is sized and shaped so that the picker 200 addressing the load opening 277A, 277B, 278A, 278B accesses the autonomous mobile robots, so as to load the at least one ordered good onto one of the autonomous mobile robots 262, through the addressed load opening 277A, 277B, 278A, 278B, that is disposed on and aligned with the corresponding outbound lane 820A, 820B.

The distribution center or breakpack transport system 266 may include one or more of the following, employed individually, in any combination thereof, and/or in any combination with the features described herein:
the one of the autonomous mobile robots 262 loaded with the at least one ordered good BPG is arranged so as to traverse the deck 130DG and transport the at least one ordered good BPG to an order container separate 264 and distinct from the storage container 265;
the loaded autonomous mobile robot 262 departs the respective load opening 277A, 277B, 278A, 278B through which the autonomous mobile robot 262 was loaded along the corresponding outbound lane 820A, 820B;
the corresponding outbound lane 820A, 820B and inbound lane 810A, 810B for the respective load opening 277A, 277B, 278A, 278B are on a common level (e.g., of the deck 130DG);
the respective load opening 277A, 277B, 278A, 278B is sized and shaped so that the autonomous mobile robot 262 disposed on the corresponding outbound lane 820A, 820B is accessed via the load opening 277A, 277B, 278A, 278B addressed by the picker 200;
the load opening 277A, 277B, 278A, 278B is arranged so as to complement access to the autonomous mobile robot 262 through the load opening 277A, 277B, 278A, 278B of at least one of a human and robot picker (generally referred to herein as picker 200);
a container output configured for communicating with an outfeed synchronous transport system or conveyor 225 to outfeed one or more of storage containers 265 holding a remaining set of goods not picked by the picker 200 and empty storage containers 265;
the movable bed 301, 302 comprises one or more of a belt conveyor, a gravity roller conveyor, a powered roller conveyor, a chain conveyor, and a ball transfer conveyor;
the at least one of the movable bed 301, 302 and static platform 310, 311 comprise an edge proximate the picker 200 and substantially level with a level of the deck 130DG;
an indication system configured to identify the addressed load opening 277A, 277B, 278A, 278B for a pick/place operation by the picker 200;
the order fill load ports 277, 278 are disposed adjacent one another so as to form a tandem pick station 222, where each pick station 201, 202 of the tandem pick station 222 includes respective load openings 277A, 277B, 278A, 278B, of the different respective load openings 277A, 277B, 278A, 278B, disposed along a respective container travel loop 230L, 231L of the deck 130DG, and each pick station 201, 202 of the tandem pick station 222 forms a goods transfer interface to effect breakpack goods BPG transfer between the storage container 265 and autonomous mobile robot 262;
the infeed conveyor 220 and the outfeed conveyor 225 are stacked one above the other;
infeed conveyor 220 and the outfeed conveyor 225 form opposing conveyor sections, the opposing conveyor sections include: two divergent conveyor sections diverging from the common infeed conveyor section; and two convergent conveyor sections converging into the common outfeed conveyor section, each convergent conveyor section being coupled to a respective divergent conveyor section so as to form the respective container travel loop 230L, 231L with the common outfeed conveyor section and the common infeed conveyor section; and
indicia 9222A-9222D configured to provide the picker 200 goods transfer instructions for transferring one or more goods from a container 265 on the infeed conveyor 220 to the autonomous mobile robot 262.

Referring again to FIG. 1, in accordance with the present disclosure the automated storage and retrieval system 100 may operate in a retail distribution center or warehouse to, for example, fulfill orders received from retail stores for case units such as those described in United States Patent number 10,822,168 issued on Nov. 3, 2020, the disclosure of which is incorporated by reference herein in its entirety. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken-down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. Shipping cases for case units (e.g. cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system the content of each pallet may be uniform (e.g. each pallet holds a predetermined number of the same item-one pallet holds soup and another pallet holds cereal) and as pallets leave the storage and retrieval system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. The storage and retrieval system 100 described herein may be applied to any environment in which case units are stored and retrieved.

In accordance with the present disclosure, orders for filled items (e.g., the pallets, cases, containers, package of goods, individual (unpacked) goods, etc.) may be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL (see, e.g., United States patent number 8,965,559 titled “Pallet Building System” and issued on February 24, 2015, the disclosure of which is incorporated herein by reference in its entirety). The pallet PAL may include mixed cases, mixed totes, mixed packs, mixed units (or eaches) per tote, etc. The sorted items are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more orthogonal sortation echelons (such as described in, for example, United States patent application number 17/358,383 filed on June 25, 2021 and titled “Warehousing System for Storing and Retrieving Goods in Containers,” the disclosure of which is incorporated herein by reference in its entirety) to a sortation level needed (e.g., e.g., the controller 120 drills/drives down through the orthogonal sortation echelons to effect the desired level of sortation needed for a given order – a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

The automated storage and retrieval system 100 includes one or more breakpack modules 266 (which may also be referred to herein as a distribution center or breakpack transport system). Exemplary breakpack modules 266 suitable for employment with the present disclosure include those described in Patent Cooperation Treaty application number PCT/US24/19932 filed on March 14, 2024 and titled “Warehousing System for Storing and Retrieving Goods in Containers” with attorney docket number 1127P015998-WO (EQV) and United States patent application number 18/605,294 filed March 14, 2024 and titled “Warehousing System for Storing and Retrieving Goods in Containers” with attorney docket number 1127P016004-US (PAR), and those described in United States patent application numbers 17/358,383 filed June 25, 2021, 17/657,705 filed April 1, 2022, and 18/323,758 filed May 25, 2023, the disclosures of which are incorporated herein by reference in their entireties. The breakpack module(s) 266 is/are configured to break down product or supply containers 265 (also referred to as case units) into breakpack goods containers 264 (also referred to herein as goods containers or totes for shipping goods) for order fulfillment. Product (e.g., good units or breakpack goods BPG) is placed into the breakpack goods containers 264 with automation (such as a goods bot 262 as described herein) such that the products are loosely placed within the breakpack goods containers 264. The breakpack goods containers 264 are automatically stacked on pallets PAL, as described herein, for shipping from the automated storage and retrieval system 100.

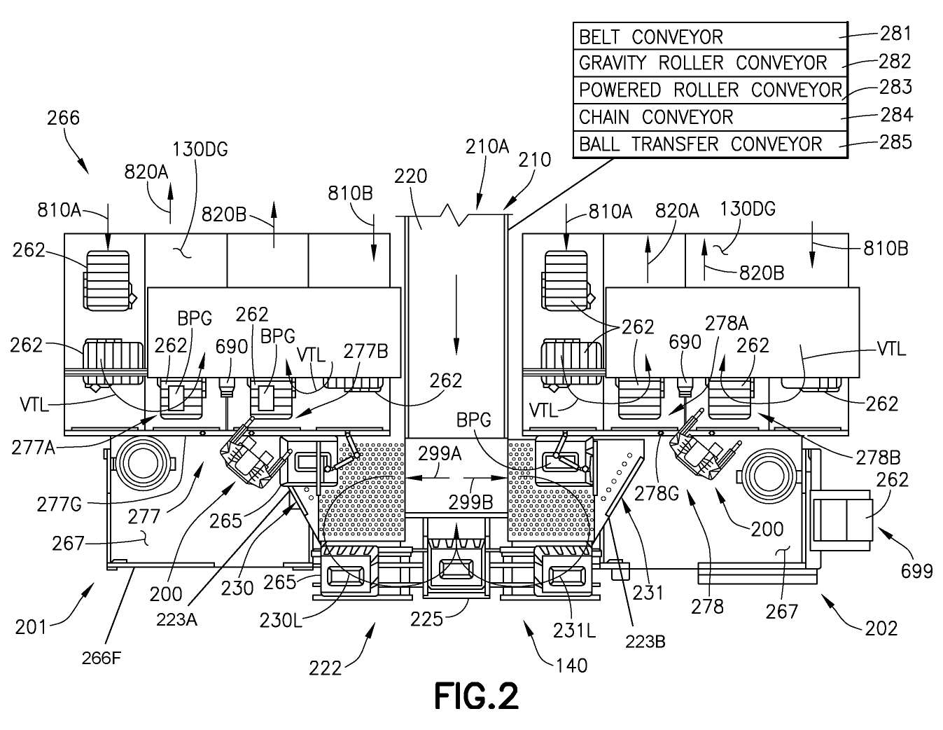

The automated storage and retrieval system 100 may include (in addition to or in lieu of the breakpack modules 266) one or more each pick modules substantially similar to those described in United States patent number 9,037,286 issued on May 19, 2015 (the disclosure of which is incorporated herein by reference), where the breakpack goods containers 264 are filled by human or robotic operators 200 (see FIG. 2, human operators are illustrated for exemplary purposes only) and output for transport by at least one autonomous container transport vehicle 110 (also referred to herein as “container bots” or “autonomous guided vehicles” and which form at least a part of an asynchronous transport system for level transport as described herein) for placement in storage or for transfer to an output station 160UT.

A controller 120 of the automated storage and retrieval system 100 is configured to effect operation of a container bot 110 and a goods bot 262 for assembling orders of goods unit(s) (also referred to herein as breakpack good(s)) BPG from supply containers 265 (e.g., case units CU) into breakpack goods containers 264 and outfeed of breakpack goods containers 264 through container output/transfer stations TS. The breakpack goods BPG are not product containers 265 (e.g., case units, pickfaces, etc.) but rather individual items (or eaches) broken down or taken from a larger unit (such as from a product container 265, where the product container 265 is opened and separated into individual items) for placement in breakpack goods container 264 with other individual items of the same or different stock keeping units for shipping to a customer/store. The breakpack goods BPG may be uncontained or an individual retail goods package for a given stock keeping unit. For example, the controller 120 may be configured to effect, through any suitable network 180 and in accordance with warehouse management system 2500 instruction, operation of the container bot(s) 110 between the container storage locations 130S, a breakpack operation (or pick) station 140 (of a breakpack module 266), and a breakpack goods container 264 located at a goods interface 263 along a breakpack goods transfer deck 130DG. The goods interface 263 may include a container conveyance 210 (see also FIG. 2) that transports supply containers 265 placed on the container conveyance by the container bot 110 to the breakpack pick station 140 where breakpack goods BPG are picked from the supply container 265 and placed into a breakpack goods container 264 by a human or automated operator (see, e.g., FIGS. 2-6 and 8A-8B illustrating a human operator, although an automated operator may be employed). The container conveyance 210 may transport empty or partially emptied supply containers 265 from the breakpack pick station 140 back to the goods interface 263 for picking and transport by the container bot(s) 110.

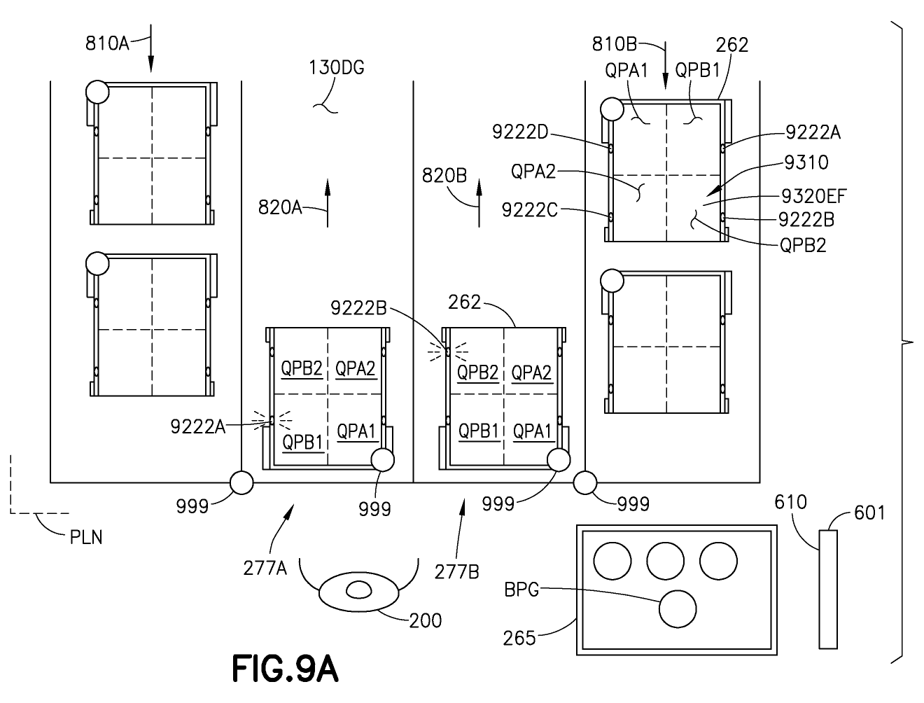

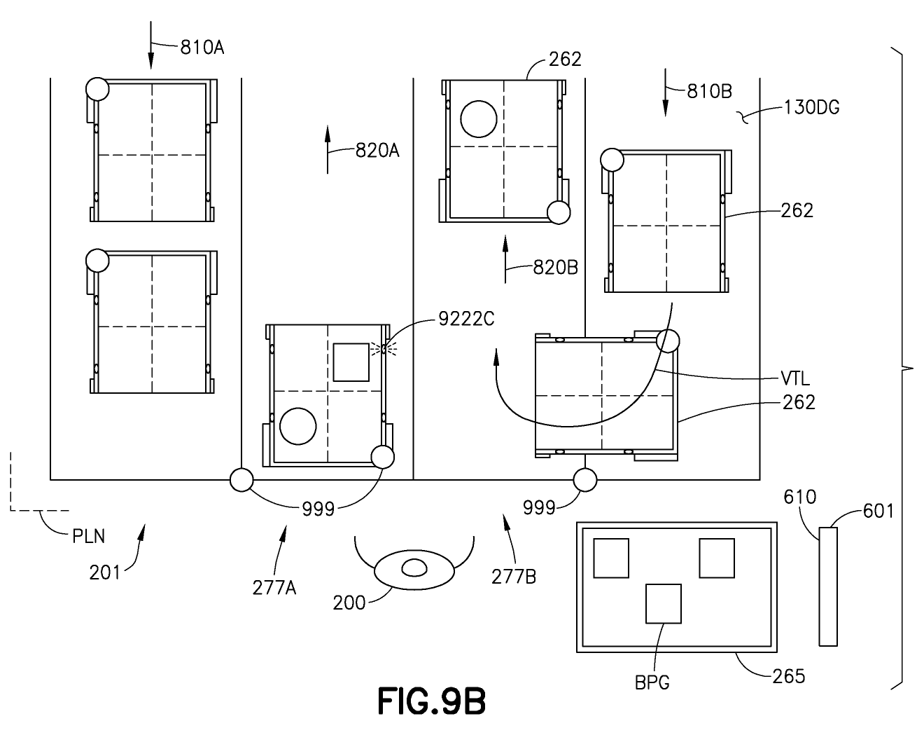

The controller 120 may be configured to effect operation of the goods bot(s) 262 so that transport of the breakpack goods BPG by the goods bot 262 traversing the goods transfer deck 130DG, sorts the breakpack goods BPG, e.g., in a unit/each level sortation, to corresponding breakpack goods containers 264. The goods transfer deck 130DG may be substantially open and configured for the undeterministic (i.e., not physically constrained) traversal of goods bots 262 along multiple travel lanes (see, e.g., FIGS. 2-6 and 8A-9B) across and along the goods transfer deck 130DG. The goods bots 262 may be automated, independent (e.g. free riding) autonomous transport vehicles. Suitable examples of container bots can be found in, for exemplary purposes only, in United States provisional patent Application number 63/657,215 filed on June 7, 2024 (having Atty. Docket No. 1127P017161-US (-#1)), the disclosure of which is incorporated herein by reference in its entirety. Referring also to FIGS. 9A and 9B, each goods bot 262 may include a payload bed 9310 that has (or forms) a placement effector 9320EF configured to transfer one or more breakpack goods BPG held in/on the payload bed 9310 to a breakpack goods container 264 located at, for example, the put wall 211. The placement effector 320EF includes discrete payload holding sections QPA1, QPA2, QPB1, QPB2 thereon, where the operator places one or more breakpack goods BPG at one or more of the place locations quadrants QA1, QA2, QB1, QB2. The goods bot 262 includes any suitable indexing indicia 9222A-9222D (e.g., including, but not limited to, a light source (e.g., light emitting diode, etc.), a movable flag, etc. – also referred to herein as an indicating system), each corresponding to a respective payload holding section QPA1, QPA2, QPB1, QPB2, that is selectively actuated to indicate to the operator a placement position of a breakpack good BPG within the payload bed 9310. The indexing indicia 9222A-9222D may be actuated based on, for example, command signals from the controller 120 (e.g., to the goods bot 262) and according to the supply container 265 (and the breakpack goods held therein) located at the breakpack pick station 140 from which a breakpack good(s) BPG is being transferred. While indexing indicia 9222A-9222D are described, any suitable indexing indicia onboard or off-board the goods bot 262 may be employed including, but not limited to, laser pointers, graphic displays, etc.

The controller 120 may be configured to effect operation of the container bot(s) 110 (e.g., traversing a container transfer deck 130DC) so that the container bot(s) 110 accesses corresponding breakpack goods containers 264 at the goods transfer deck 130DG, such as from a put wall 211 where an array of breakpack goods containers 264 are disposed, and transports the breakpack goods containers 264 via traverse along the container transfer deck 130DC to at least one of a container output/transfer station TS, a buffer station BS, and/or a corresponding container storage location 130SB of the storage spaces 130S (formed by storage shelves 130SS) of a corresponding level 130L of a multilevel storage array (i.e., storage structure 130). The buffer stations BS may be disposed at any suitable location within a respective storage structure level 130L such as within a picking aisle 130A, along the container deck 130DC, and/or provided with or adjacent the container output/transfer station TS to facilitate container transfer between the container bot(s) 110 and lift modules 150A, 150B. It is noted that one or more than one level 130L of the (multilevel) storage structure includes at least one respective breakpack module 266 (see FIG. 3 showing at least two levels 130L each with a respective breakpack module 266).

It is noted that when, for example, incoming bundles or pallets (also referred to as pallet loads) IPAL (e.g. from manufacturers or suppliers of case units) arrive at the storage and retrieval system 100 for replenishment of the automated storage and retrieval system 100, the content of each pallet IPAL may be uniform (e.g. each pallet holds a predetermined number of the same item-one pallet holds soup and another pallet holds cereal). The cases or containers of such pallet IPAL may be substantially similar or in other words, homogenous cases (e.g. similar dimensions), and may have the same SKU (otherwise, as noted before the pallets may be “rainbow” pallets having layers formed of homogeneous containers). As pallets PAL leave the storage and retrieval system 100, with containers, such as the breakpack goods containers 264, filling customer replenishment orders, the pallets PAL may contain any suitable number and combination of different containers (e.g., uncontained goods/case units, goods on trays, in totes, and/or in other suitable containers) and/or breakpack goods BPG (e.g., each pallet may hold different types of case units and/or breakpack goods in containers-a pallet holds a combination of canned soup, cereal, beverage packs, cosmetics and household cleaners).

The storage and retrieval system 100 may be configured to generally include an in-feed section, a storage and sortation section (where storage of items is optional), and an output section. The storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units or supply containers 265 handled individually by the system 100, retrieve and sort the different supply containers 265 sought by each order into corresponding groups, and transport and assemble the corresponding groups of supply containers 265 and/or breakpack goods BPG in breakpack goods containers 264 (e.g., at the output station 160UT) into what may be referred to as mixed case pallet loads (see pallet load PAL noted above). The system 100 operating, for example, as a retail distribution center may serve to receive uniform pallet loads IPAL of cases, breakdown the pallet goods or disassociate the cases from the uniform pallet loads (e.g., at the input station 160IN) into independent supply containers 265 handled individually by the system, retrieve and sort the different containers sought by each order into corresponding groups, and transport and sequence the corresponding groups of containers in the manner described in United States patent number 9,856,083 issued on January 2, 2018, the disclosure of which is incorporated herein by reference in its entirety.

The storage and sortation section includes a multilevel automated storage system that has an automated transport system that in turn receives or feeds individual supply containers 265 into the multilevel storage array for storage in a storage area (such as storage spaces 130S of the storage structure 130). The storage and sortation section also defines outbound transport of containers from the multilevel storage array such that desired case units are individually retrieved in accordance with commands generated in accordance to orders entered into a warehouse management system, such as warehouse management system 2500, for transport to the output section.

The storage and sortation section may receive individual supply containers 265 and/or breakpack goods containers 264, sort the individual containers (utilizing, for example, container buffer stations BS and container output/transfer stations TS described herein), e.g., in a container level sortation, and transfer the individual containers to the output section in accordance to orders entered into the warehouse management system. The sorting and grouping of containers according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, United States patent number 8,965,559 issued on February 24, 2015 and titled “Pallet Building System,” the disclosure of which is incorporated herein by reference in its entirety.

In the present disclosure, the output section generates a pallet load LPAL in what may be referred to as a structured architecture of mixed container stacks. The structured architecture of the pallet load described herein is representative however; the pallet load may have any other suitable configuration. For example, the structured architecture may be any suitable predetermined configuration such as a truck bay load or other suitable container or load container envelope holding a structural load.

Still referring to FIG. 1, the automated storage and retrieval system 100 includes a storage array (e.g., storage structure 130 with storage shelves 130SS forming or otherwise having storage spaces 130S) with at least one elevated storage level 130L (where more than one elevated storage levels forms storage racks of stacked storage levels). Mixed product units are input and distributed in the storage array in supply containers 265 of product units of common kind per container (each container input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers 265) to lift modules (or lifts) 150A for entry into a storage level 130L of the storage structure 130).

The automated storage and retrieval system 100 includes an automated transport system (e.g., bots, breakpack stations, and other suitable level transports described herein) with at least one asynchronous transport system for transporting cases/products on a given storage structure level 130L (e.g., level transport). The storage and retrieval system 100 includes undeterministic container bots 110 that travel along one or more physical pathways of the storage and retrieval system (e.g., such as one or more of the picking aisles 130A and container transfer deck 130DC) to provide at least one level of asynchronicity. The container bots 110 may be any suitable independently operable autonomous transport vehicles that carry and transfer containers along X and Y (planar) throughput axes throughout the storage and retrieval system 100. The container bots 110 may be automated, independent (e.g. free riding) autonomous transport vehicles. Suitable examples of container bots can be found in, for exemplary purposes only, United States patent number 10,822,168 issued on Nov. 3, 2020; United States patent number 8,425,173 issued on Apr. 23, 2013; United States patent number 9,561,905 issued on Feb. 7, 2017; United States patent number 8,965,619 issued on February 24, 2015; United States patent number 8,696,010 issued on Apr. 15, 2014; United States patent number 9,187,244 issued on Nov. 17, 2015; United States Patent number 11,078,017 issued on Aug. 3, 2021; United States patent number 9,499,338 issued on Nov. 22, 2016; United States patent number 10,894,663 issued on Jan. 19, 2021; and United States patent number 9,850,079 issued on Dec. 26, 2017, the disclosures of which are incorporated by reference herein in their entireties. The container bots 110 may be configured to place containers, such as the above-described retail merchandise, into picking stock in the one or more levels of the storage structure 130 and then selectively retrieve ordered containers.

At least another level of asynchronicity is provided such that, for example, container/product holding locations are greater than the number of bots transporting containers/products. At least one lift module (or lift) 150B is provided for transporting containers/products between storage levels 130L (e.g., between level transport). The at least one lift 150B is communicably connected to the storage array (e.g., formed by the storage spaces 130S of the storage level(s) 130L) so as to automatically retrieve and output, from the storage array, product units distributed in the containers in a common part (e.g., the storage locations 130S of a respective storage level 130L) of the at least one elevated storage level 130L of the storage array. The output product units being one or more of mixed singulated product units, in mixed packed groups, and in mixed containers. As an example, the automated storage and retrieval system 100 includes output stations 160UT, 160EC (which include palletizers 160PB, operator stations 160EP and/or conveyors 160CB for transporting items (e.g., outbound supply containers 265 and filled breakpack goods (order) containers 264) from lift modules 150B for removal from storage (e.g., to a palletizer (for palletizer load) or to a truck (for truck load)). The output station 160EC may be an individual fulfillment (or e-commerce) output station where, for example, filled breakpack goods (order) containers 264 including single goods items and/or small bunches of goods are transported for fulfilling an individual fulfillment order (such as an order placed over the Internet by a consumer). The output station 160UT may be a commercial output station where large numbers of goods are generally provided on pallets for fulfilling orders from commercial entities (e.g., commercial stores, warehouse clubs, restaurants, etc.). The automated storage and retrieval system 100 may include both the commercial output station 160UT and the individual fulfillment output station 160EC although, the automated storage and retrieval system may include one or more of the commercial output station 160UT and the individual fulfillment output station 160EC.

The automated storage and retrieval system 100 also includes input and output vertical lift modules 150A, 150B (generally referred to as lift modules 150 – it is noted that while input and output lift modules are shown, a single lift module may be used to both input and remove case units from the storage structure), a storage structure 130 (which may have at least one elevated storage level as noted above and may form a multilevel storage array), and at least one container bot 110 which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g. storage and sorting section) noted above, which has an integral “on the fly sortation” (e.g. sortation of case units during transport of the case units) so that case unit sorting and throughput occurs substantially simultaneously without dedicated sorters as described in United States patent number 9,856,083, previously incorporated herein by reference in its entirety.

The lifts 150 may be connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in United States patent number 9,856,083, previously incorporated by reference herein in its entirety and United States patent number 10,822,168 issued on Nov. 3, 2020, the disclosure of which is incorporated herein by reference in its entirety.

The container transfer decks 130DC may be substantially open and configured for the undeterministic (i.e., not physically constrained) traversal of container bots 110 along multiple travel lanes across and along the container transfer decks 130DC. As described in United States patent number 10,556,743 issued on February 11, 2020 and having application number 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. The container transfer deck(s) 130DC at each storage level 130L communicate with each of the picking aisles 130A on the respective storage level 130L.

Still referring again to FIG. 1, each storage level 130L may also include charging stations 130C for charging an on-board power supply of the container bots 110 on that storage level 130L such as described in, for example, United States patent application number 14/209,086 filed on March 13, 2014 and United States patent number 9,082,112 issued on July 14, 2015, the disclosures of which are incorporated herein by reference in their entireties.

Referring to FIGS. 1, 1A, and 1B, two or more breakpack modules 266 may be stacked vertically one above the other (or arranged side-by-side laterally) in a manner similar to that described in United States Patent No. 12,168,572 issued on December 17, 2024, the disclosure of which is incorporated herein by reference in its entirety. Three breakpack modules 266A, 266B, 266C are illustrated as being stacked vertically one above the other however, any suitable number of breakpack modules 266 may be stacked one above the other or arranged side-by-side. Each breakpack module 266 (whether arranged in a stack or not) may receive inbound supply containers 265 from any one or more of the stacked levels 130L, e.g., via the containers bots 110 and one or more breakpack module lift(s) BML (each lift serving in one or more of an inbound or outbound transfer role, where container bots 110 may deliver supply containers 265 to a breakpack module lift BML and the lift may transport the supply container 265 to a predetermined one of the stacked breakpack modules 266). For example, each breakpack module 266 includes at least a portion of at least one container deck 130EXT, each container deck 130EXT having a container bot riding surface 266RS. In FIG. 1B, each breakpack module 266A-266C includes three container bot riding surfaces 266RS1, 266RS2, 266RS3. The container bot riding surfaces 266RS1, 266RS2, 266RS3 being stacked one above the other. Each container bot riding surface 266RS1, 266RS2, 266RS3/container deck 130EXT is coupled to and forms a portion of a container deck 130DC on a respective level 130L of the automated storage and retrieval system 100 such that each breakpack module 266A-266C services three storage levels 130L of the automated storage and retrieval system 100. The riding surface 266RS1-266RS3 is substantially similar to that of container transfer deck 130DC, although the container bot riding surface 266RS may be substantially similar to that of the picking aisles 130A. For ease of explanation, the container bot riding surface 266RS within the breakpack module 266 are referred to herein as a portion of the container transfer deck 130DC.

Referring to FIGS. 1, 1A, 1B, and 2, the breakpack pick station 140 includes a frame 266F to which the components of the breakpack pick station 140 described herein are connected.

The breakpack pick station includes a container conveyor 210A and at least one tandem pick station 222 (also referred to as a tandem operator station) and a portion of the breakpack goods transfer deck 130DG. The container conveyor 210A may form a part of, or is otherwise in communication with (e.g., for transferring supply containers 265) the container conveyance 210. The container conveyor 210A includes a common infeed conveyor section 220 (also referred to herein as an infeed synchronous transport system or conveyor) and a common outfeed conveyor section 225, the common infeed conveyor section 220 and common outfeed conveyor section 225 being common to (or shared by) each pick station 201, 202 of the tandem pick station 222 at the breakpack pick station 140. The common infeed conveyor section 220 and the common outfeed conveyor station 225 are coupled to each other by opposing conveyor sections 230, 231, where the opposing conveyor sections 230, 231 form respective container travel loops 230L, 231L between the common infeed conveyor section 220 and the common outfeed conveyor section 225. Although a tandem pick station 222 is described herein, it should be understood that the pick station may not be a tandem pick station such as where the pick station includes only one conveyor section 230, 231 having a respective container travel loop 230L, 231L.

The common infeed conveyor section 220 (also referred to as an infeed synchronous transport system or conveyor) is a synchronous transport system that is configured to transport supply containers 265 to the tandem pick station 222 substantially directly from a container bot 110 and/or from a breakpack module lift BML. A container bot 265 may deliver supply container(s) 265 to a container bot transfer station 192 of the breakpack module 266, where the container bot transfer station 192 is configured to effect, in any suitable manner, a transfer of the supply container 265 from the container bot 110 to the common infeed conveyor section 220. The common infeed conveyor section 220 interfaces, in any suitable manner, with the breakpack module lifts BML for transferring supply containers 265 from the breakpack module lifts BML to the common infeed conveyor section.

The common outfeed conveyor section 225 (also referred to as an outfeed synchronous transport system or conveyor) is a synchronous transport system that is configured to transport supply containers 265 (empty or partially full (e.g., partially filled with unpicked goods)) from the tandem pick station 222.

Empty supply containers 265 may be directed by the common outfeed conveyor section 225 to an empty container disposal area ECD of the automated storage and retrieval system 100. Supply container 265 that are partially filled may be directed back to storage by the common outfeed conveyor section 225, such as through a container bot transfer station 193, where the container bot transfer station 193 is configured to effect, in any suitable manner, a transfer of the supply container 265 from the common outfeed conveyor section 225 to the container bot 110. The common outfeed conveyor section 225 may interface, in any suitable manner, with the breakpack module lifts BML for transferring supply containers 265 from the common outfeed conveyor section 225 to the breakpack module lifts BML, such as for transferring a partially filled supply container 265 to a different storage level 130L or an empty supply container to an empty container disposal area ECD on a different level of the automated storage and retrieval system 100 than the breakpack module 266 to which the common outfeed conveyor section 225 belongs.

Referring also to FIGS. 3-6, common infeed conveyor section 220 and the common outfeed conveyor section 225 are stacked one above the other. Stacking the common infeed conveyor section 220 and the common outfeed conveyor section 225 may reduce the footprint or space occupied by the breakpack pick station 140 on the facility floor.

The breakpack pick station 140 includes a side 223A, 223B connected to the frame 266F, where the side 223A, 223B is disposed at an angle with respect to autonomous goods vehicle interfaces 277A, 277B, 278A, 278B (also referred to herein as load openings) of the breakpack pick station 140.

The side 223A, 223B may be formed by, or at least a portion of, the opposing conveyor sections 230, 231 as illustrated in the figures.

The opposing conveyor sections 230, 231 include two divergent conveyor sections 301, 302 (also referred to herein as movable beds) diverging from the common infeed conveyor section 220 and two convergent conveyor sections 320, 321 converging into the common outfeed conveyor section 225. Each convergent conveyor section 320, 321 is coupled to a respective divergent conveyor section 301, 302 so as to form the respective container travel loop 230L, 231L with the common outfeed conveyor section 225 and the common infeed conveyor section 220. For example, each of the opposing conveyor sections 230, 321 includes a divergent conveyor section 301, 302, a container buffer 310, 311 (also referred to herein as a static platform), and a convergent conveyor section 320, 321.

Each of the two divergent conveyor sections 301, 302 may be one or more of a belt conveyor, a gravity roller conveyor, a powered roller conveyor, a chain conveyor, and a ball transfer conveyor (see the belt conveyor 281, a gravity roller conveyor 282, a powered roller conveyor 283, a chain conveyor 284, and a ball transfer conveyor 285).

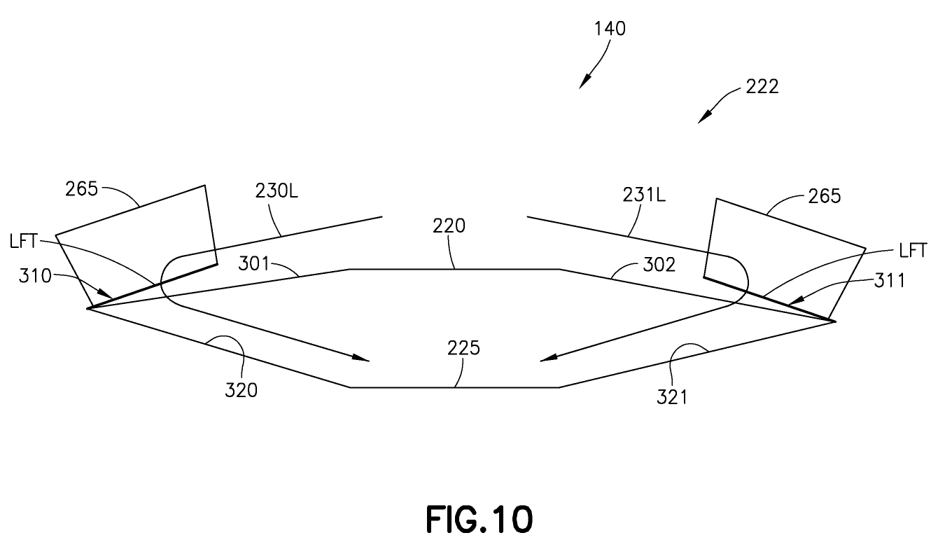

The container buffer 310, 311 couples or otherwise communicably connects a respective divergent conveyor section 301, 302 and a respective convergent conveyor section 320, 321 to each other for transferring supply containers 265 between the divergent conveyor section 301, 302 and convergent conveyor section 320, 321. The container buffer 310, 311 may be configured as a tilt tray or lift LFT (see FIG. 10) that is configured (e.g., with any suitable linear and/or rotary actuators) to tilt or lift a supply container 265 held on the buffer 310, 311 to any suitable ergonomic position that facilitates an ergonomic picking of a breakpack good BPG from the supply container 265.

As can be seen in the figures, the two divergent conveyor sections 301, 302 and the container buffer 310, 311 include an edge proximate the operator 200 (e.g., human or robotic-also referred to herein as a picker) and substantially level with a level of the deck 130DG.

The side 223A, 223B includes a container input interface configured for communicating with the common infeed conveyor section 220 in feeding the storage container 265, with a set of goods therein, to the tandem pick station 222, wherein the container input interface includes at least one of divergent conveyor sections 301, 302 and the container buffer 310, 311, posed adjacent the respective autonomous goods vehicle interfaces 277A, 277B, 278A, 278B so that a picker 200 of the at least one good (BPG), picked from the storage container 265 in fed via the container input interface addresses the respective autonomous goods vehicle interfaces 277A, 277B, 278A, 278B of each goods transfer interface 277, 278 with substantially one step.

The container conveyance 210 comprises one or more of (see FIG. 2) a belt conveyor 281, a gravity roller conveyor 282, a powered roller conveyor 283, a chain conveyor 284, a ball transfer conveyor 285, and any other suitable type of conveyor for transporting the supply containers 265. For example, the common infeed conveyor section 220 and common outfeed conveyor section 225 may include portions that are belt conveyors 281, portions that are powered roller conveyors 283, and/or portions that are gravity roller conveyors 282 although, any suitable type of conveyors may be employed. The transfer conveyor 220T may be a powered roller conveyor 283, or any other suitable conveyor, so that supply containers 265 slide onto the transfer conveyor 220T from the belt conveyor portion of the common infeed conveyor section 220 and where the power roller conveyor 283 drives the supply containers 265 in one of both directions 299A, 299B for transferring the supply containers 265 to the divergent conveyor section 301, 302. The divergent conveyor sections 301, 302 may be ball transfer conveyors 285 such that gravity drives the supply containers 265 along the divergent conveyor sections 301, 302 to a respective container buffer 310, 311 although, any suitable type of conveyor may be employed. The container buffers 310, 311 may be ball transfer conveyors 285, or other suitable type of conveyor, to facilitate the operator 200 (e.g., human or robotic) pushing of the supply containers 265 from the container buffer 310, 311 to the convergent conveyor section 320, 321 (the supply container 265 may be pushed across a portion of the divergent conveyor section 301, 302 travelling from the container buffer 310, 311 to the convergent conveyor section 320, 321). The convergent conveyor sections 320, 321 may be a chain conveyor 284, or other suitable type of conveyor, that drives supply containers 265 from the container buffers 310, 311 (and/or the divergent conveyor sections 301, 302) to the common outfeed conveyor section 225.

The divergent conveyor section 301, 302 is disposed on a respective side of the common infeed conveyor section 220 for receiving supply containers 265 from the common infeed conveyor section 220. The common infeed conveyor section 220 includes a transfer conveyor section 220T for selectively moving the supply containers 265 in one of both directions 299A, 299B to a selected or otherwise predetermined one of the divergent conveyor sections 301, 302. Each of the divergent conveyor sections 301, 302 is communicably coupled to a respective container buffer 310, 311 so as to transfer supply containers 265 to a respective container buffer 310, 311 for providing the operator 200 (e.g., human or robotic) access to the supply container 265. Operator 200 access to the supply containers 265 at the container buffer 310, 311 effects transfer (e.g., by the operator 200) of breakpack goods BPG from the supply containers 265 to a goods bot 262 as described herein. The container buffer 310, 311 is communicably coupled to a respective convergent conveyor section 320, 321 for transferring the supply containers 265 (e.g., empty or partially empty after operator 200 picking of the breakpack goods BPG from the supply containers 265) to the common outfeed conveyor section 225.

Each pick station 201, 202 of the tandem pick station 222 is disposed along a respective container travel loop 230L, 231L. For example, pick station 201 is disposed along the container travel loop 230L and the pick station 202 is disposed along the container travel loop 231L. Each pick station 201, 202 of the tandem pick station 222 forms a goods transfer interface 277, 278 (also referred to herein as order fill load ports) that effects breakpack goods BPG transfer between the containers (e.g., such as the supply containers 265) transported by the container conveyance 210 and autonomous goods transport vehicles 262 of a respective breakpack module 266.

The goods transfer interface 277, 278 may include at least one autonomous goods transport vehicle interface 277G, 278G. Each pick station 201, 202 of the tandem pick station 222 is disposed between the at least one autonomous goods transport vehicle interface 277G, 278G and the respective container travel loop 230L, 231L. The at least one autonomous goods transport vehicle interface 277G, 278G and the respective container travel loop 230L, 231L may be located on adjacent sides of the pick station 201, 202. For example, as illustrated in, e.g., FIG. 2-4, at pick station 201 the respective container travel loop 230L (and the respective container buffer 310) is located (with respect to an operator 200 (e.g., human or robotic) stationed at the pick station 201, and facing the breakpack goods transfer deck 130DG) to the right hand side of the operator and the at least one autonomous goods transport vehicle interface 277G is located on an adjacent side of the pick station 201 in front of the operator 200. Similarly, at pick station 202 the respective container travel loop 231L (and the respective container buffer 311) is located (with respect to an operator 200 stationed at the pick station 202, and facing the breakpack goods transfer deck 130DG) to the left-hand side of the operator 200 and the at least one autonomous goods transport vehicle interface 278G is located on an adjacent side of the pick station 201 in front of the operator 200.

The pick stations 201, 202 include an operator deck 267 on which the operator 200 (e.g., human or robotic) traverses/stands for accessing the supply containers 265 and the autonomous goods transport vehicles 262 disposed at the at least one autonomous goods transport vehicle interface 277G, 278G.

As illustrated in FIGS. 2-6, each of the at least one at least one autonomous goods transport vehicle interface 277G, 278G includes two side-by-side autonomous goods vehicle interfaces 277A, 277B, 278A, 278B (also referred to herein as load openings), where the operator deck 267 provides operator 200 (e.g., human or robotic) access to each respective autonomous goods vehicle interfaces 277A, 277B, 278A, 278B.

Each of the autonomous goods vehicle interfaces 277A, 277B, 278A, 278B is arranged with respect to the goods deck 130DG so that each autonomous goods vehicle interfaces 277A, 277B, 278A, 278B has at least a corresponding outbound lane 820A, 820B, and the autonomous goods vehicle interfaces 277A, 277B, 278A, 278B is sized and shaped so that a picker 200 addressing the autonomous goods vehicle interfaces 277A, 277B, 278A, 278B accesses the autonomous goods transport vehicles 262 (also referred to herein as goods bots), through the addressed autonomous goods vehicle interfaces 277A, 277B, 278A, 278B, disposed on and aligned with the corresponding outbound lane 820A, 820B.

Each of the autonomous goods vehicle interfaces 277A, 277B, 278A, 278B is sized and shaped so that the autonomous goods transport vehicles 262 disposed on a corresponding outbound lane 820A, 820B is accessed via the autonomous goods vehicle interfaces 277A, 277B, 278A, 278B addressed by the operator 200.

Each of the autonomous goods vehicle interfaces 277A, 277B, 278A, 278B is arranged so as to complement access to the autonomous goods transport vehicles 262 through the autonomous goods vehicle interfaces 277A, 277B, 278A, 278B of at least one of a human and robot picker (e.g., human or robotic operator).

Each of the autonomous goods vehicle interfaces 277A, 277B, 278A, 278B includes a respective autonomous goods transport vehicle travel loop VTL along which the autonomous goods transport vehicles 262 travel on the breakpack goods transfer deck 130DG to effect operator 200 (e.g., human or robotic) access to the autonomous goods transport vehicles 262. The breakpack goods transfer deck 130DG at each of the autonomous goods vehicle interfaces 277A, 277B, 278A, 278B (and at the at least one autonomous goods transport vehicle interface 277G, 278G in general) is substantially open and configured for the undeterministic (i.e., not physically constrained) traversal of goods bots 262 on a single or common plane PLN (e.g., the respective autonomous goods transport vehicle travel loops VTL, and the at least one inbound vehicle travel lane 810A, 810B and at least one outbound vehicle travel lane 820A, 820B thereof, are in the single or common plane PLN).

Each of the autonomous goods transport vehicles 262 is configured to transfer the breakpack goods BPG, placed to the autonomous goods transport vehicles 262 by the operator 200 (e.g., human or robotic), from the pick stations 201, 202 to order containers or breakpack goods containers 264 disposed at a container interface 263 (see FIG. 1). The container bots 110 are configured to transfer the breakpack goods containers 264 to and from the container interface 263. Breakpack goods containers 263 specified, such as by control server 120 or warehouse management system 2500, for shipping are transported by the container bots 110 from the container interface 263 to the buffer stations BS or transfer stations TS on a respective storage level 130L for transfer (e.g., by lift modules 150B, output conveyors 160CB, etc.) to the output station 160UT or individual fulfillment output station(s) 160EC for order fulfillment.

Referring also to FIGS. 1-6, 8A, 8B, 9A, and 9B, each pick station 201, 202 includes a dual inbound lane and dual outbound lane configuration that effects a pick-to-put discriminatory payload placement (e.g., in at least two directions) to each goods bot 262 located in zones (e.g., autonomous goods vehicle interfaces 277A, 277B, 278A, 278B) that are juxtaposed to each other. The breakpack goods transfer deck 130DC may define, at each goods transfer interface 277, 278 dual inbound vehicle travel lanes 810A, 810B and dual outbound vehicle travel lane 820A, 820B, where the at least one inbound vehicle travel lane 810A, 810B and at least one outbound vehicle travel lane 820A, 820B are coplanar with each other along the same or common plane PLN.

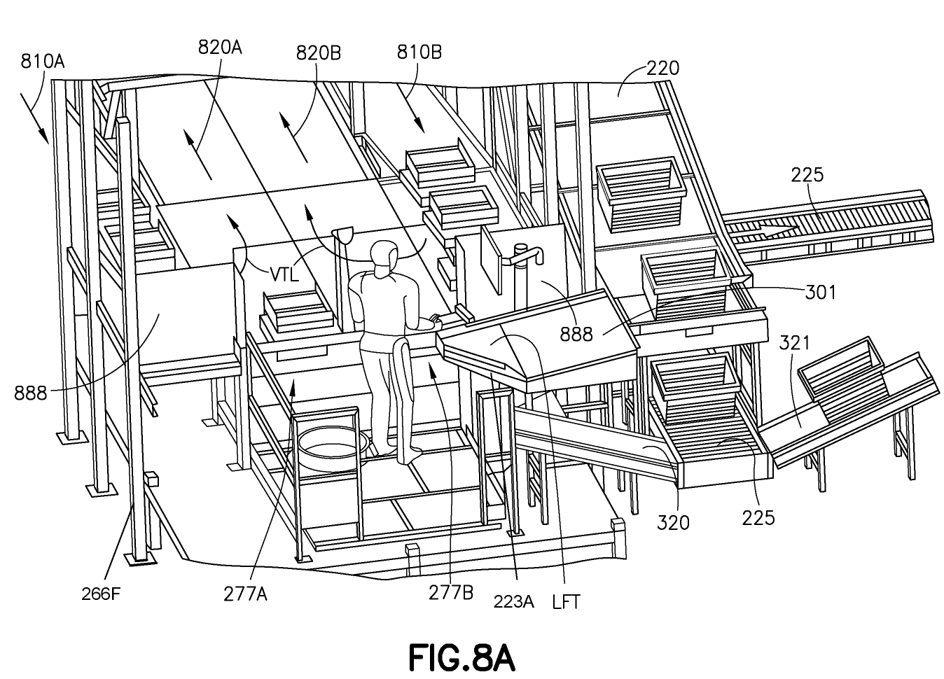

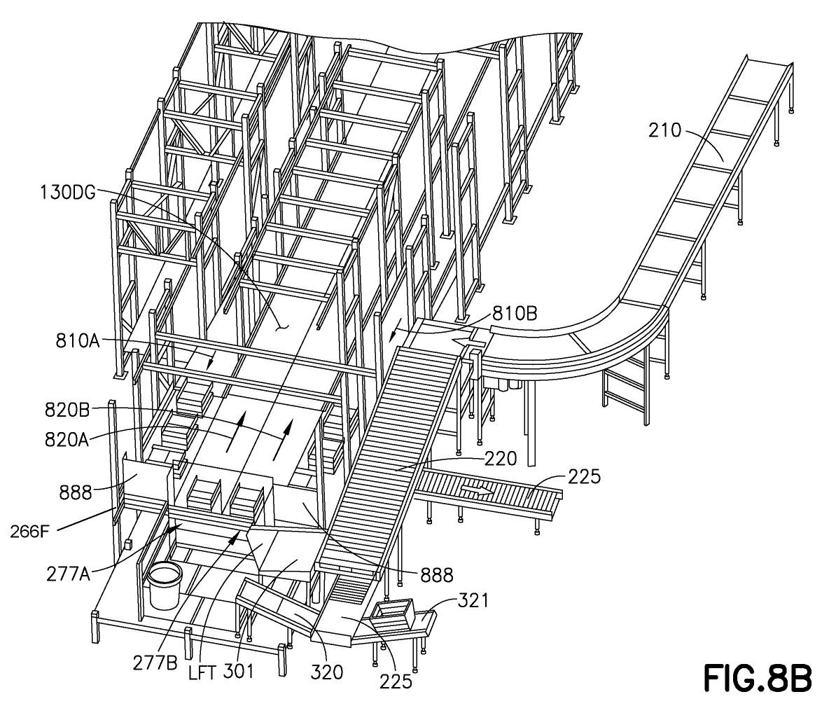

The outbound travel lanes 820A, 820B are arranged side-by-side and are substantially aligned with the respective side-by-side autonomous goods vehicle interfaces 277A, 277B, 278A, 278B (e.g., juxtaposed zones). For example, referring to FIGS. 8A-9B, outbound travel lane 820A is substantially aligned with (e.g., in-line with) autonomous goods vehicle interface 277A and outbound travel lane 820B is substantially aligned with (e.g., in-line with) autonomous goods vehicle interface 277B. While side-by-side autonomous goods vehicle interfaces 278A, 278B are not illustrated in FIGS. 8A-9B (only one half of the tandem pick station 222 is illustrated), the side-by-side autonomous goods vehicle interfaces 278A, 278B are aligned with respective outbound vehicle travel lane 820A, 820B in the manner illustrated with respect to side-by-side autonomous goods vehicle interfaces 277A, 277B.

The inbound vehicle travel lanes 820A, 820B are located to a side of the respective side-by-side autonomous goods vehicle interfaces 277A, 277B, so as to be substantially parallel with and disposed alongside a respective outbound vehicle travel lane 820A, 820B (e.g., offset from the respective side-by-side autonomous goods vehicle interfaces 277A, 277B, 278A, 278B). For example, inbound travel lane 810A is located alongside, to the left, of the outbound vehicle travel lane 820A so as to be offset (e.g., on the left side) of the autonomous goods vehicle interface 277A. Inbound travel lane 810B is located alongside, to the right, of the outbound vehicle travel lane 820B so as to be offset (e.g., on the right side) of the autonomous goods vehicle interface 277B.

The goods bots 262 are located at the autonomous goods vehicle interfaces 277A, 277B, 278A, 278B for receiving breakpack goods BPG from an operator 200 (e.g., human or robotic) in a pick-to-put operation. For example, the operator 200 picks one or more breakpack goods from a supply container 265 located at the buffer 310, 311 for placement in one or more of the discrete payload holding sections QPA1, QPA2, QPB1, QPB2 of the one or more goods bots 262 located at the respective autonomous goods vehicle interfaces 277A, 277B, 278A, 278B of the respective pick station 201, 202. As each pick station 201, 202 has two side-by-side autonomous goods vehicle interfaces 277A, 277B, 278A, 278B, at each of which is a good bot 262, the operator 200 is presented with eight discrete payload holding sections QPA1, QPA2, QPB1, QPB2 at which a breakpack good BPG may be placed.

The pick stations 201, 202 may each include, at least, indicia 601, 602 configured to, at least in part, provide the operator 200 (e.g., human or robotic) of each pick station 201, 202 of the tandem pick stations 201, 202 goods transfer instructions for transferring one or more breakpack goods BPG from a supply container 265 on the container conveyance 210 to an autonomous goods transport vehicle 262 located at one or more of the two side-by-side autonomous goods vehicle interfaces 277A, 277B, 278A, 278B. For example, the indicia 601, 602 may be presented on any suitable display, such as a monitor 610, where the indicia 601, 602 may provide a quantity of breakpack goods BPG to be transferred from the supply container 265 to a given goods bot 262. The indicia 601, 602 may indicate to which of the autonomous goods vehicle interfaces 277A, 277B, 278A, 278B the breakpack goods BPG are to be transferred to. The goods bots 262 may include the indexing indicia 9222A-9222D that are actuated to instruct the operator 200 that breakpack good(s) are to be placed in a predetermined one of the payload holding section QPA1, QPA2, QPB1, QPB2 of a goods bot 262 located at the indicated autonomous goods vehicle interfaces 277A, 277B, 278A, 278B. For example, the monitor 610 may indicate a quantity of breakpack goods BPG to be transferred to a goods bot 262 and the indexing indicia 9222A-9222D of the goods bots 262 indicates which goods bot(s) 262 is to receive the quantity of breakpack goods BPG and to which the payload holding section QPA1, QPA2, QPB1, QPB2 of the goods bot 262 the breakpack good(s) is/are to be placed, although the monitor 610 may provide both the quantity of breakpack goods BPG to be picked and the place location of the breakpack goods BPG. The pick stations 201, 202 may include any suitable sensors 690 (e.g., laser scanners, light curtains, cameras, etc.) that detect or otherwise verify proper placement of breakpack goods BPG into the goods bot 262 at a predetermined autonomous goods vehicle interface 277A, 277B, 278A, 278B, although the goods bot 262 may include any suitable sensors (e.g., laser scanners, light curtains, cameras, etc.) that detect or otherwise verify proper placement of breakpack goods BPG into the goods bot 262.

Each pick station 201, 202 of the tandem pick station 222 may include shielding or any other suitable barrier 888 disposed at an end of each inbound vehicle travel lane 810A, 810B, where the barrier 888 may be configured to substantially prevent egress of a goods bot 262 from the breakpack goods transfer deck 130DG. The barrier 888 may isolate the operator 200 (e.g., human or robotic) from the goods bot 262 travelling along the inbound vehicle travel lane 810A, 810B so that the goods bot 262 may travel at high speed (e.g., 4 mph or greater, although slower speeds may be employed) along the inbound vehicle travel lane 810A, 810B (e.g., a high speed (e.g., 4 mph or greater, although slower speeds may be employed) approach to the pick station 201, 202). Traverse of the goods bot 262 from the inbound vehicle travel lane 810A, 810B to the autonomous goods vehicle interface 277A, 277B, 278A, 278B may be at a low speed (e.g., lower than a speed of the high-speed approach), where the operator 200 places the breakpack goods BPG in the goods bot with the goods bot 262 stopped at the autonomous goods vehicle interface 277A, 277B, 278A, 278B. Departure of the goods bot 262 from the autonomous goods vehicle interface 277A, 277B, 278A, 278B along the outbound vehicle travel lane 820A, 820B may be a high-speed departure (e.g., at the same speed or greater speed than the high-speed approach, such as with a maximum acceleration of the goods bot 262 and a time optimal trajectory). To effect the high speed departure of the goods bot 262, one or more of the goods bot 262 and pick station 201, 202 may include proximity sensors 999 (e.g., light curtains, through beam sensors, cameras, etc.) configured to indicate/confirm to, for example, controller 120 or a controller of the departing goods bot 262 that a fast depart condition exists (e.g., the fast depart condition being where the operator 200 is spatially away, by at least a predetermined distance, from the departing goods bot 262. The interaction/interfacing/guarding between the goods bot 262 and the operator 200 (e.g., human or robotic) at the pick station 201, 202 may be in conformance with any suitable/applicable industry standards including, but not limited to, one or more of: ANSI/RIA R15.06-2012, RIA TR R15.606-2016, RIA TR R15.306-2016, RIA TR R15.406-2014, RIA TR R15.806-2018, RIA TR R15.706-2019, ISO/TS 15066:2016, ISO 10218-1, ISO 10218-2, and ISO 13849.

Referring to FIGS. 9A and 9B, in a pick-to-put operation the movement of the goods bots 262 to and from each autonomous goods vehicle interfaces 277A, 277B, 278A, 278B is independent of each other autonomous goods vehicle interfaces 277A, 277B, 278A, 278B. For example, referring to autonomous goods vehicle interfaces 277A, 277B (similar operation may be effected at autonomous vehicle interfaces 278A, 278B), a goods bot 262 may be located at each of the autonomous goods vehicle interfaces 277A, 277B for receiving one or more breakpack goods BPG. A supply container 265 may be delivered to the pick station 201 and the monitor 610 may indicate to the operator 200 (e.g., human or robotic) that two breakpack goods BPG are to be removed from the supply container 265, where one breakpack good BPG is to be placed in each of the two goods bots 262. The indexing indicia 9222B of the goods bot 262 at the autonomous goods vehicle interface 277B may be actuated indicating to the operator 200 breakpack goods placement at payload holding section QPB2. The indexing indicia 9222A of the goods bot 262 at autonomous goods vehicle interface 277A may be actuated indicating to the operator 200 breakpack goods BPG placement at payload holding sections QPB1. The goods bot 262 at autonomous goods vehicle interface 277B is to receive only the single breakpack good BPG while the goods bot 262 at autonomous goods vehicle interface 277B is to receive another breakpack good BPG. With transfer of breakpack goods at autonomous goods vehicle interface 277B complete, the goods bot departs autonomous goods vehicle interface 277B along outbound vehicle travel lane 820B and another goods bot 262 traverses to the autonomous goods vehicle interface 277B from the inbound vehicle travel lane 810B, while the goods bot 262 at autonomous goods vehicle interface 277A remains stationary. With exchange of the goods bots 262 at autonomous goods vehicle interface 277B, another supply container 265 arrives at the pick station 201 and the monitor 610 may indicate to the operator 200 that one breakpack goods BPG is to be removed from the supply container 265, where the breakpack good BPG is to be placed in the two goods bot 262 at autonomous goods vehicle interface 277A. The indexing indicia 9222A of the goods bot 262 at autonomous goods vehicle interface 277A may be actuated indicating to the operator 200 breakpack goods BPG placement at payload holding sections QPA2, after which placement the goods bot 262 departs autonomous goods vehicle interface 277A along outbound vehicle travel lane 820A and another goods bot 262 traverses to the autonomous goods vehicle interface 277A from the inbound vehicle travel lane 810A. As such, each goods bots 262 may arrive and depart from the autonomous goods vehicle interfaces 277A, 277B, 278A, 278B as needed/when transfer for a given goods bot 262 is complete, independent of breakpack goods BPG at another of the autonomous goods vehicle interfaces 277A, 277B, 278A, 278B (e.g., the operator has random access to the payload holding sections QPA1, QPA2, QPB1, QPB2 of each goods bot 262 at each autonomous goods vehicle interfaces 277A, 277B, 278A, 278B of a respective pick station 201, 202 where the place position/order of the breakpack goods BPG is freely selectable, such as by the controller 120 or goods bot controller).

The pick stations 201, 202 may effect induction or removal of the goods bots 262 to and from the breakpack module 266. One or more of the tandem pick stations 201, 202 may have a goods bot input/output station 699 configured to hold one or more goods bots 262. The operator deck 267 provides operator 200 (e.g., human or robotic) access to the goods bot input/output station 699 so that the operator 200 may transport a goods bot 262 between breakpack goods transfer deck 130DG, e.g., through respective autonomous goods vehicle interfaces 277A, 277B, 278A, 278B, and the goods bot input/output station 699.

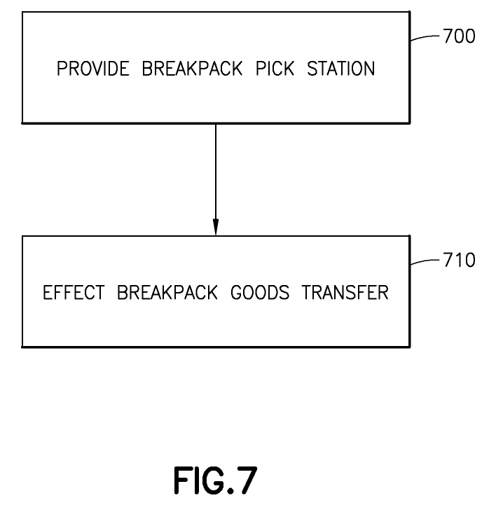

Still referring to FIGS. 1-6 and also to FIGS. 7-10, an exemplary method for transferring breakpack goods BPG at a breakpack pick station 140 in an automated storage and retrieval system 100 will be described. The method includes providing the breakpack pick station 140 (FIG. 7, Block 700). As described herein, the breakpack pick station includes the container conveyance 210, where the container conveyance 210 includes a common infeed conveyor section 220 and a common outfeed conveyor section 225 being coupled to each other by opposing conveyor sections 230, 231. The opposing conveyor sections 230, 231 forming respective container travel loops 230L, 231L between the common infeed conveyor section 220 and the common outfeed conveyor section 225. The breakpack pick station 140 includes the tandem pick station 222, where each pick station 201, 202 of the tandem pick station 222 is disposed along a respective container travel loop 230L, 231L and each pick station 201, 202 of the tandem pick station 222 forms the goods transfer interface 277, 278. Breakpack goods BPG transfer is effected (FIG. 7, Block 710), at the goods transfer interface 277, 278, between the supply containers 265 transported by the container conveyance 210 and the autonomous goods transport vehicles 262.

The method may include one or more of the following features (which may be employed individually, in any combination with each other, and/or in any combination with the features described herein): the common infeed conveyor and the common outfeed conveyor are stacked one above the other; the opposing conveyor sections comprise: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; providing an operator of each pick station of the tandem pick station goods transfer instructions for transferring one or more goods from a container on the container conveyance to autonomous goods transport vehicle, the instruction being presented through indicia of the breakpack pick station; the container conveyance comprises one or more of a belt conveyor, a gravity roller conveyor, a powered roller conveyor, chain conveyor, and a ball transfer conveyor; the goods transfer interface includes at least one autonomous goods transport vehicle interface, each pick station of the tandem pick station being disposed between the at least one autonomous goods transport vehicle interface and the respective container travel loop; the at least one autonomous goods transport vehicle interface comprises two side-by-side autonomous goods transport vehicle interfaces for each pick station; and each autonomous goods transport vehicle interface comprises an autonomous goods transport vehicle travel loop.

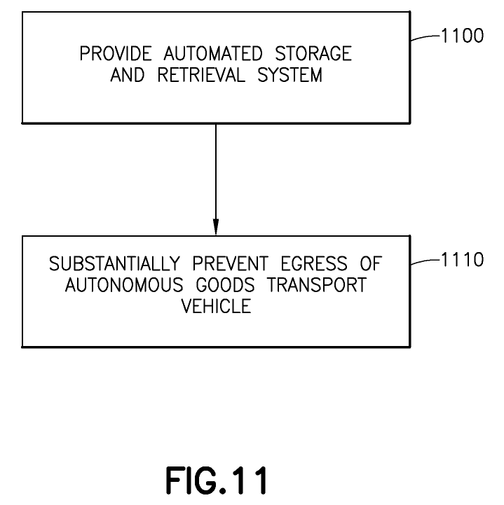

Referring to FIGS. 1-6 and 8A-11, a method for transferring breakpack goods at a breakpack pick station in an automated storage and retrieval system 100 will be described in accordance with the present disclosure. The method includes providing an automated storage and retrieval system 100 (FIG. 11, Block 1100). As described herein, the automated storage and retrieval system 100 includes at least one autonomous goods transport vehicle 262 and a pick station 140 configured to effect breakpack goods transfer between containers 265 disposed at the pick station 140 and the at least one autonomous goods transport vehicle 262. The pick station 140 has an autonomous vehicle interface 277G, 278G; and a transfer deck 130DG adjacent the autonomous vehicle interface 277G, 278G. The transfer deck 130DG has a first travel loop VTL formed by a first inbound vehicle travel lane 810A and a first outbound vehicle travel lane 820A and a second travel loop VTL formed by a second inbound vehicle travel lane 810B and a second outbound vehicle travel lane 820B, where the at least one autonomous goods transport vehicle 262 traverses the transfer deck 130DG along the first travel loop VTL and second travel loop VTL for breakpack goods transfer to the at least one autonomous goods transport vehicle 262 at the autonomous vehicle interface 277G, 278G. The method further includes substantially preventing egress of the at least one autonomous goods transport vehicle 262 (FIG. 11, Block 1110), from a respective one of the first inbound vehicle travel lane 810A and the second inbound vehicle travel lane 810B to the pick station 140, with a barrier 888 disposed between the pick station 140 and each of the first inbound vehicle travel lane 810A and the second inbound vehicle travel lane 810B.

The method may include one or more of the following, employed individually, in any combination with each other, and/or in any combination with the features described above: the at least one autonomous goods transport vehicle 262 departs the autonomous vehicle interface, along the first outbound vehicle travel lane 820A or the second outbound vehicle travel lane 820B, at a high speed with a maximum acceleration of the at least one autonomous goods transport vehicle 262 and a time optimal trajectory; the pick station 140 comprises one or more sensors 999, where the method further comprises confirming, with the one or more sensors 999, to a controller (such as controller 120 or a controller of the departing goods bot 262) of the automated storage and retrieval system 100 that a fast depart condition exists so as to effect, with the controller, departure of the at least one autonomous goods transport vehicle 262 from the autonomous vehicle interface 277G, 278G at the high speed; the at least one autonomous goods transport vehicle 262 approaches the pick station 140, along the first inbound vehicle travel lane 810A or the second inbound vehicle travel lane 810B, at a high speed; the pick station 140 comprises a tandem pick station 222 having: a container conveyance 210 comprising a common infeed conveyor section 220 and a common outfeed conveyor section 225 being coupled to each other by opposing conveyor sections 230, 231, the opposing conveyor sections 230, 231 forming respective container travel loops 230L, 231L between the common infeed conveyor section 220 and the common outfeed conveyor section 225, and each pick station 201, 202 of the tandem pick station 222 is disposed along a respective container travel loop 230L, 231L and each pick station 201, 202 of the tandem pick station 222 forms a goods transfer interface 277, 278 to effect breakpack goods transfer between the containers 265 transported by the container conveyance and the at least one autonomous goods transport vehicle 262; the common infeed conveyor 220 and the common outfeed conveyor 225 are stacked one above the other; the opposing conveyor sections 230, 231 comprise: two divergent conveyor sections 301, 302 diverging from the common infeed conveyor section 220, and two convergent conveyor sections 320, 321 converging into the common outfeed conveyor section 225, each convergent conveyor section 320, 321 being coupled to a respective divergent conveyor section 301, 302 so as to form the respective container travel loop 230L, 231L with the common outfeed conveyor section 225 and the common infeed conveyor section 220; providing, with indicia 9222A-9222D, an operator of each pick station 140 of the tandem pick station 222 goods transfer instructions for transferring one or more goods from a container 265 on the container conveyance 210 to autonomous goods transport vehicle 262; the container conveyance 210 comprises one or more of a belt conveyor 281, a gravity roller conveyor 282, a powered roller conveyor 283, chain conveyor 284, and a ball transfer conveyor 285; the goods transfer interface 277, 278 of a respective pick station 140 includes a respective autonomous vehicle interface 277G, 278G, the respective pick station 140 being disposed between the respective autonomous vehicle interface 277G, 278G and the respective container travel loop 230L, 231L; and the respective autonomous vehicle interface 277G, 278G comprises two side-by-side autonomous vehicle interfaces 277A, 277B, 278A, 278B, each of the two side-by-side autonomous vehicle interfaces 277A, 277B, 278A, 278B corresponding to a respective one of the first travel loop VTL and the second travel loop VTL.

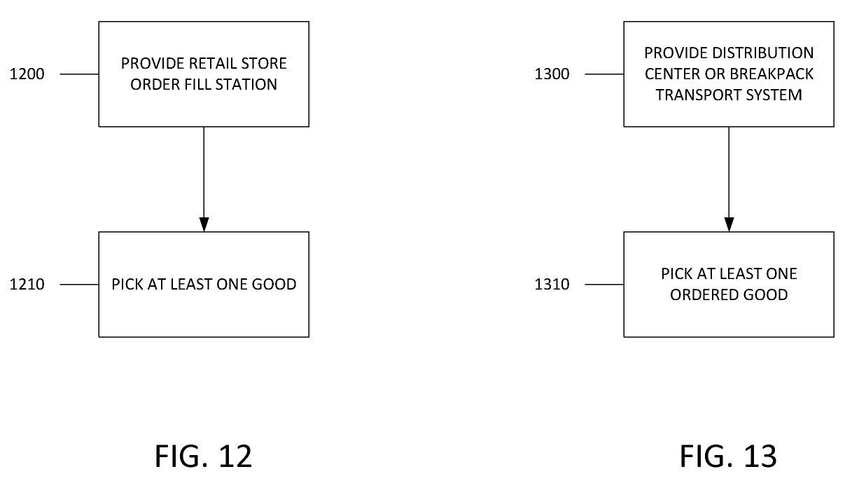

Referring to FIGS. 1-6, 8A-10, and 12, an exemplary method, in a retail store order fill station 140, for removing at least one good from a storage container of a set of goods, and placement of the at least one good in an order container, will be described. The method includes providing the retail store order fill station 140 (such as described herein) (FIG. 12, Block 1200).

The retail store order fill station 140 may include one or more of the following: a frame 266F that forms more than one order fill load ports 277, 278, each of which has a different respective load opening 277A, 277B, 278A, 278B facing a deck 130DG of an asynchronous transport system (e.g., including at least the goods bots 262), where autonomous mobile robots 262 (also referred to as goods bots 262) autonomously traverse the deck 130DG so as to form an inbound lane 810A, 810B and an outbound lane 820A, 820B along which the autonomous mobile robots 262 respectively arrive to and depart from each load opening 277A, 277B, 278A, 278B, wherein the load opening 277A, 277B, 278A, 278B of each respective order fill load port 277, 278 is separate and distinct from each other order fill load port 277, 278; and a side 223A, 223B connected to the frame 266F, the side 223A, 223B being disposed at an angle with respect to the load opening 277A, 277B, 278A, 278B of each order fill load port 277, 278, and has a container input interface configured for communicating with an infeed synchronous transport system or conveyor 220 in feeding the storage container 265, with the set of goods BPG, to the retail order fill station 140, wherein the container input interface includes at least one of a movable bed 301, 302 and static platform 310, 311, posed adjacent the respective load opening of each order fill load port 277, 278.

A picker 200 picks the at least one good BPG (FIG. 12, Block 1210) from the storage container 265 in fed via the container input interface, where the picker addresses the respective load opening 277A, 277B, 278A, 278B of each order fill load port 277, 278 with substantially one step; where each respective load opening 277A, 277B, 278A, 278B is arranged with respect to the deck 130DG so that each respective load opening 277A, 277B, 278A, 278B has at least a corresponding outbound lane 820A, 820B, and the load opening 277A, 277B, 278A, 278B is sized and shaped so that the picker 200 addressing the load opening 277A, 277B, 278A, 278B accesses the autonomous mobile robots 262, through the addressed load opening 277A, 277B, 278A, 278B, disposed on and aligned with the corresponding outbound lane 820A, 820B.

The method may include one or more of the following, employed individually, in any combination with each other, and/or in any combination with the features described above:
the one of the autonomous mobile robots 262 loaded with at least one good BPG is arranged so as to traverse the deck 130DG and transport the at least one ordered good BPG to an order container 264 separate and distinct from the storage container 265;
the loaded autonomous mobile robot 262 departs the respective load opening 277A, 277B, 278A, 278B through which the autonomous mobile robot 262 was loaded along the corresponding outbound lane 820A, 820B;
the corresponding outbound lane 820A, 820B and inbound lane 810A, 810B for the respective load opening 277A, 277B, 278A, 278B are on a common level;
the respective load opening 277A, 277B, 278A, 278B is sized and shaped so that the autonomous mobile robot(s) 262 disposed on the corresponding outbound lane 820A, 820B is/are accessed via the load opening 277A, 277B, 278A, 278B addressed by the picker 200;
the load opening 277A, 277B, 278A, 278B is arranged so as to complement access to the autonomous mobile bots through the load opening of at least one of a human and robot picker (generally referred to herein as picker 200).
a container output configured for communicating with an outfeed synchronous transport system or conveyor 225 to outfeed one or more of storage containers 265 holding a remaining set of goods not picked by the picker 200 and empty storage containers 265.
the movable bed 301, 302 comprises one or more of a belt conveyor, a gravity roller conveyor, a powered roller conveyor, a chain conveyor, and a ball transfer conveyor.
the at least one of the movable bed 301, 302 and static platform 310, 311 comprise an edge proximate the picker 200 and substantially level with a level of the deck 130DG.
an indication system configured to identify the addressed load opening 277A, 277B, 278A, 278B for a pick/place operation by the picker 200;
the order fill load ports 277, 278 are disposed adjacent one another so as to form a tandem pick station 222, where each pick station 201, 202 of the tandem pick station 222 includes respective load openings 277A, 277B, 278A, 278B, of the different respective load openings, disposed along a respective container travel loop 230L, 231L of the deck 130DG, and each pick station 201, 202 of the tandem pick station 222 forms a goods transfer interface to effect breakpack goods BPG transfer between the storage container 265 and autonomous mobile robot 262;
the infeed conveyor 220 and the outfeed conveyor 225 are stacked one above the other;
infeed conveyor 220 and the outfeed conveyor 225 form opposing conveyor sections, the opposing conveyor sections include: two divergent conveyor sections diverging from a common infeed conveyor section; and two convergent conveyor sections converging into a common outfeed conveyor section, each convergent conveyor section being coupled to a respective divergent conveyor section so as to form the respective container travel loop 230L, 231L with the common outfeed conveyor section and the common infeed conveyor section; and
indicia 9222A-9222D configured to provide the picker 200 goods transfer instructions for transferring one or more goods BPG from a container 265 on the infeed conveyor 220 to the autonomous mobile robot 262.

Referring to FIGS. 1-6, 8A-10, and 13, an exemplary method, in a distribution center or breakpack transport system 266, for filling at least one ordered good BPG, will be described. The method includes providing the distribution center or breakpack transport system 266 (FIG. 13, Block 1300).

The distribution center or breakpack transport system 266 includes one of more of the following: an asynchronous transport system (e.g., including at least the goods bots 262) having a deck 130DG with autonomous mobile robots 262 (also referred to herein as goods bots) autonomously traversing the deck 130DG; a breakpack order fill station 140 connected to the deck 130DG, the station having: a frame 266F that forms more than one order fill load ports 277, 278, each of which has a different respective load opening 277A, 277B, 278A, 278B facing the deck 130DG of the asynchronous transport system, the autonomous mobile robots 262 traverse the deck 130DG so as to form an inbound lane 810A, 810B and an outbound lane 820A, 820B along which the autonomous mobile robots 262 respectively arrive to and depart from each load opening 277A, 277B, 278A, 278B, wherein the load opening 277A, 277B, 278A, 278B of each respective order fill load port 277, 278 is separate and distinct from each other order fill load port 277, 278; and a side 223A, 2223B connected to the frame 266F, the side 223A, 223B being disposed at an angle with respect to the load opening 277A, 277B, 278A, 278B of each order fill load port 277, 278, and has a container input interface configured for communicating with an infeed synchronous transport system or conveyor 220 in feeding a storage container 265, holding a set of goods BPG (also referred to herein as breakpack goods), to the breakpack order fill station 140, wherein the container input interface includes at least one of a movable bed 301, 302 and static platform 310, 311, posed adjacent the respective load opening 277A, 277B, 278A, 278B of each order fill load port 277, 278.

A picker 200 picks the at least one ordered good BPG (FIG. 13, Block 1310) from the storage container 265 in fed via the container input interface, where the picker 200 addresses the respective load opening 277A, 277B, 278A, 278B of each order fill load port 277, 278 with substantially one step; where each respective load opening 277A, 277B, 278A, 278B is arranged with respect to the deck 130DG so that each respective load opening 277A, 277B, 278A, 278B has at least a corresponding outbound lane 820A, 820B, and the load opening 277A, 277B, 278A, 278B is sized and shaped so that the picker 200 addressing the load opening 277A, 277B, 278A, 278B accesses the autonomous mobile robots, so as to load the at least one ordered good onto one of the autonomous mobile robots 262, through the addressed load opening 277A, 277B, 278A, 278B, that is disposed on and aligned with the corresponding outbound lane 820A, 820B.

The method may include one or more of the following, employed individually, in any combination with each other, and/or in any combination with the features described above:
the one of the autonomous mobile robots 262 loaded with the at least one ordered good BPG is arranged so as to traverse the deck 130DG and transport the at least one ordered good BPG to an order container separate 264 and distinct from the storage container 265;
the loaded autonomous mobile robot 262 departs the respective load opening 277A, 277B, 278A, 278B through which the autonomous mobile robot 262 was loaded along the corresponding outbound lane 820A, 820B;
the corresponding outbound lane 820A, 820B and inbound lane 810A, 810B for the respective load opening 277A, 277B, 278A, 278B are on a common level (e.g., of the deck 130DG);
the respective load opening 277A, 277B, 278A, 278B is sized and shaped so that the autonomous mobile robot 262 disposed on the corresponding outbound lane 820A, 820B is accessed via the load opening 277A, 277B, 278A, 278B addressed by the picker 200;
the load opening 277A, 277B, 278A, 278B is arranged so as to complement access to the autonomous mobile robot 262 through the load opening 277A, 277B, 278A, 278B of at least one of a human and robot picker (generally referred to herein as picker 200);
a container output configured for communicating with an outfeed synchronous transport system or conveyor 225 to outfeed one or more of storage containers 265 holding a remaining set of goods not picked by the picker 200 and empty storage containers 265;
the movable bed 301, 302 comprises one or more of a belt conveyor, a gravity roller conveyor, a powered roller conveyor, a chain conveyor, and a ball transfer conveyor;
the at least one of the movable bed 301, 302 and static platform 310, 311 comprise an edge proximate the picker 200 and substantially level with a level of the deck 130DG;
an indication system configured to identify the addressed load opening 277A, 277B, 278A, 278B for a pick/place operation by the picker 200;
the order fill load ports 277, 278 are disposed adjacent one another so as to form a tandem pick station 222, where each pick station 201, 202 of the tandem pick station 222 includes respective load openings 277A, 277B, 278A, 278B, of the different respective load openings 277A, 277B, 278A, 278B, disposed along a respective container travel loop 230L, 231L of the deck 130DG, and each pick station 201, 202 of the tandem pick station 222 forms a goods transfer interface to effect breakpack goods BPG transfer between the storage container 265 and autonomous mobile robot 262;
the infeed conveyor 220 and the outfeed conveyor 225 are stacked one above the other;
infeed conveyor 220 and the outfeed conveyor 225 form opposing conveyor sections, the opposing conveyor sections include: two divergent conveyor sections diverging from the common infeed conveyor section; and two convergent conveyor sections converging into the common outfeed conveyor section, each convergent conveyor section being coupled to a respective divergent conveyor section so as to form the respective container travel loop 230L, 231L with the common outfeed conveyor section and the common infeed conveyor section; and
indicia 9222A-9222D configured to provide the picker 200 goods transfer instructions for transferring one or more goods from a container 265 on the infeed conveyor 220 to the autonomous mobile robot 262.

The following features of the present disclosure are provided and may be employed individually, in any combination with each other, and/or in any combination with the features described above.

A retail store order fill station for removing at least one good from a storage container of a set of goods, and placement of the at least one good in an order container, is provided. The retail store order fill station includes: a frame that forms more than one order fill load ports, each of which has a different respective load opening facing a deck of an asynchronous transport system, where autonomous mobile robots autonomously traverse the deck so as to form an inbound lane and an outbound lane along which the autonomous mobile robots respectively arrive to and depart from each load opening, wherein the load opening of each respective order fill load port is separate and distinct from each other order fill load port; and a side connected to the frame, the side being disposed at an angle with respect to the load opening of each order fill load port, and has a container input interface configured for communicating with an infeed synchronous transport system or conveyor in feeding the storage container, with the set of goods, to the retail order fill station, wherein the container input interface includes at least one of a movable bed and static platform, posed adjacent the respective load opening of each order fill load port so that a picker of the at least one good, picked from the storage container in fed via the container input interface addresses the respective load opening of each order fill load port with substantially one step; and wherein each respective load opening is arranged with respect to the deck so that each respective load opening has at least a corresponding outbound lane, and the load opening is sized and shaped so that the picker addressing the load opening accesses the autonomous mobile robots, through the addressed load opening, disposed on and aligned with the corresponding outbound lane.

The retail store order fill station may include one or more of the following, employed individually, in any combination thereof, and/or in any combination with the features described herein: the respective load opening is sized and shaped so that the autonomous mobile robot disposed on the corresponding outbound lane is accessed via the load opening addressed by the picker; the load opening is arranged so as to complement access to the autonomous mobile robot through the load opening of at least one of a human and robot picker; a container output configured for communicating with an outfeed synchronous transport system or conveyor to outfeed one or more of storage containers holding a remaining set of goods not picked by the picker and empty storage containers; the movable bed includes one or more of a belt conveyor, a gravity roller conveyor, a powered roller conveyor, a chain conveyor, and a ball transfer conveyor; the at least one of the movable bed and static platform include an edge proximate the picker and substantially level with a level of the deck; an indication system configured to identify the addressed load opening for a pick/place operation by the picker; the order fill load ports are disposed adjacent one another so as to form a tandem pick station, where each pick station of the tandem pick station includes respective load openings, of the different respective load openings, disposed along a respective container travel loop of the deck, and each pick station of the tandem pick station forms a goods transfer interface to effect breakpack goods transfer between the storage container and autonomous mobile robot; the infeed conveyor and the outfeed conveyor are stacked one above the other; infeed conveyor and the outfeed conveyor form opposing conveyor sections, the opposing conveyor sections include: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; and indicia configured to provide the picker goods transfer instructions for transferring one or more goods from a container on the infeed conveyor to the autonomous mobile robot.

A distribution center or breakpack transport system for filling at least one ordered good is provided. The distribution center or breakpack transport system includes: an asynchronous transport system having a deck with autonomous mobile robots autonomously traversing the deck, and a breakpack order fill station connected to the deck. The breakpack order fill station having: a frame that forms more than one order fill load ports, each of which has a different respective load opening facing the deck of the asynchronous transport system, the autonomous mobile robots traverse the deck so as to form an inbound lane and an outbound lane along which the autonomous mobile robots respectively arrive to and depart from each load opening, wherein the load opening of each respective order fill load port is separate and distinct from each other order fill load port; and a side connected to the frame, the side being disposed at an angle with respect to the load opening of each order fill load port, and has a container input interface configured for communicating with an infeed synchronous transport system or conveyor in feeding a storage container, holding a set of goods, to the breakpack order fill station, wherein the container input interface includes at least one of a movable bed and static platform, posed adjacent the respective load opening of each order fill load port so that a picker of the at least one ordered good, picked from the storage container in fed via the container input interface addresses the respective load opening of each order fill load port with substantially one step; and wherein each respective load opening is arranged with respect to the deck so that each respective load opening has at least a corresponding outbound lane, and the load opening is sized and shaped so that the picker addressing the load opening accesses the autonomous mobile robots, so as to load the at least one ordered good onto one of the autonomous mobile robots, through the addressed load opening, that is disposed on and aligned with the corresponding outbound lane.

The distribution center or breakpack transport system may include one or more of the following, employed individually, in any combination thereof, and/or in any combination with the features described herein: the one of the autonomous mobile robots loaded with the at least one ordered good is arranged so as to traverse the deck and transport the at least one ordered good to an order container separate and distinct from the storage container; the loaded autonomous mobile robot departs the respective load opening through which the autonomous mobile robot was loaded along the corresponding outbound lane; the corresponding outbound lane and inbound lane for the respective load opening are on a common level; the respective load opening is sized and shaped so that the autonomous mobile robot disposed on the corresponding outbound lane is accessed via the load opening addressed by the picker; the load opening is arranged so as to complement access to the autonomous mobile robot through the load opening of at least one of a human and robot picker; a container output configured for communicating with an outfeed synchronous transport system or conveyor to outfeed one or more of storage containers holding a remaining set of goods not picked by the picker and empty storage containers; the movable bed includes one or more of a belt conveyor, a gravity roller conveyor, a powered roller conveyor, a chain conveyor, and a ball transfer conveyor; the at least one of the movable bed and static platform include an edge proximate the picker and substantially level with a level of the deck; an indication system configured to identify the addressed load opening for a pick/place operation by the picker; the order fill load ports are disposed adjacent one another so as to form a tandem pick station, where each pick station of the tandem pick station includes respective load openings, of the different respective load openings, disposed along a respective container travel loop of the deck, and each pick station of the tandem pick station forms a goods transfer interface to effect breakpack goods transfer between the storage container and autonomous mobile robot; the infeed conveyor and the outfeed conveyor are stacked one above the other; infeed conveyor and the outfeed conveyor form opposing conveyor sections, the opposing conveyor sections include: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; and indicia configured to provide the picker goods transfer instructions for transferring one or more goods from a container on the infeed conveyor to the autonomous mobile robot.

A method, in a retail store order fill station, for removing at least one good from a storage container of a set of goods, and placement of the at least one good in an order container, is provided. The method includes providing the retail store order fill station. The retail store order fill station includes: a frame that forms more than one order fill load ports, each of which has a different respective load opening facing a deck of an asynchronous transport system, where autonomous mobile robots autonomously traverse the deck so as to form an inbound lane and an outbound lane along which the autonomous mobile robots respectively arrive to and depart from each load opening, wherein the load opening of each respective order fill load port is separate and distinct from each other order fill load port; and a side connected to the frame, the side being disposed at an angle with respect to the load opening of each order fill load port, and has a container input interface configured for communicating with an infeed synchronous transport system or conveyor in feeding the storage container, with the set of goods, to the retail order fill station, wherein the container input interface includes at least one of a movable bed and static platform, posed adjacent the respective load opening of each order fill load port. The method includes picking, with a picker, the at least one good, picked from the storage container in fed via the container input interface, where the picker addresses the respective load opening of each order fill load port with substantially one step; and wherein each respective load opening is arranged with respect to the deck so that each respective load opening has at least a corresponding outbound lane, and the load opening is sized and shaped so that the picker addressing the load opening accesses the autonomous mobile robots, through the addressed load opening, disposed on and aligned with the corresponding outbound lane.

The method may include one or more of the following, employed individually, in any combination thereof, and/or in any combination with the features described herein: the respective load opening is sized and shaped so that the autonomous mobile robot disposed on the corresponding outbound lane is accessed via the load opening addressed by the picker; the load opening is arranged so as to complement access to the autonomous mobile robot through the load opening of at least one of a human and robot picker; a container output configured for communicating with an outfeed synchronous transport system or conveyor to outfeed one or more of storage containers holding a remaining set of goods not picked by the picker and empty storage containers; the movable bed includes one or more of a belt conveyor, a gravity roller conveyor, a powered roller conveyor, a chain conveyor, and a ball transfer conveyor; the at least one of the movable bed and static platform include an edge proximate the picker and substantially level with a level of the deck; an indication system configured to identify the addressed load opening for a pick/place operation by the picker; the order fill load ports are disposed adjacent one another so as to form a tandem pick station, where each pick station of the tandem pick station includes respective load openings, of the different respective load openings, disposed along a respective container travel loop of the deck, and each pick station of the tandem pick station forms a goods transfer interface to effect breakpack goods transfer between the storage container and autonomous mobile robot; the infeed conveyor and the outfeed conveyor are stacked one above the other; infeed conveyor and the outfeed conveyor form opposing conveyor sections, the opposing conveyor sections include: two divergent conveyor sections diverging from the common infeed conveyor section and two convergent conveyor sections converging into the common outfeed conveyor section, each convergent conveyor section being coupled to a respective divergent conveyor section so as to form the respective container travel loop with the common outfeed conveyor section and the common infeed conveyor section; and indicia configured to provide the picker goods transfer instructions for transferring one or more goods from a container on the infeed conveyor to the autonomous mobile robot.

A method, in a distribution center or breakpack transport system, for filling at least one ordered good is provided. The method includes providing the distribution center or breakpack transport system. The distribution center or breakpack transport system includes: an asynchronous transport system having a deck with autonomous mobile robots autonomously traversing the deck, and a breakpack order fill station connected to the deck. The breakpack order fill station having: a frame that forms more than one order fill load ports, each of which has a different respective load opening facing the deck of the asynchronous transport system, the autonomous mobile robots traverse the deck so as to form an inbound lane and an outbound lane along which the autonomous mobile robots respectively arrive to and depart from each load opening, wherein the load opening of each respective order fill load port is separate and distinct from each other order fill load port; and a side connected to the frame, the side being disposed at an angle with respect to the load opening of each order fill load port, and has a container input interface configured for communicating with an infeed synchronous transport system or conveyor in feeding a storage container, holding a set of goods, to the breakpack order fill station, wherein the container input interface includes at least one of a movable bed and static platform, posed adjacent the respective load opening of each order fill load port. The method includes picking, with a picker, the at least one ordered good, picked from the storage container in fed via the container input interface, where the picker addresses the respective load opening of each order fill load port with substantially one step; and wherein each respective load opening is arranged with respect to the deck so that each respective load opening has at least a corresponding outbound lane, and the load opening is sized and shaped so that the picker addressing the load opening accesses the autonomous mobile robots, so as to load the at least one ordered good onto one of the autonomous mobile robots, through the addressed load opening, that is disposed on and aligned with the corresponding outbound lane.

The method may include one or more of the following, employed individually, in any combination thereof, and/or in any combination with the features described herein: the one of the autonomous mobile robots loaded with the at least one ordered good is arranged so as to traverse the deck and transport the at least one ordered good to an order container separate and distinct from the storage container; the loaded autonomous mobile robot departs the respective load opening through which the autonomous mobile robot was loaded along the corresponding outbound lane; the corresponding outbound lane and inbound lane for the respective load opening are on a common level; the respective load opening is sized and shaped so that the autonomous mobile robot disposed on the corresponding outbound lane is accessed via the load opening addressed by the picker; the load opening is arranged so as to complement access to the autonomous mobile robot through the load opening of at least one of a human and robot picker; a container output configured for communicating with an outfeed synchronous transport system or conveyor to outfeed one or more of storage containers holding a remaining set of goods not picked by the picker and empty storage containers; the movable bed includes one or more of a belt conveyor, a gravity roller conveyor, a powered roller conveyor, a chain conveyor, and a ball transfer conveyor; the at least one of the movable bed and static platform include an edge proximate the picker and substantially level with a level of the deck; an indication system configured to identify the addressed load opening for a pick/place operation by the picker; the order fill load ports are disposed adjacent one another so as to form a tandem pick station, where each pick station of the tandem pick station includes respective load openings, of the different respective load openings, disposed along a respective container travel loop of the deck, and each pick station of the tandem pick station forms a goods transfer interface to effect breakpack goods transfer between the storage container and autonomous mobile robot; the infeed conveyor and the outfeed conveyor are stacked one above the other; infeed conveyor and the outfeed conveyor form opposing conveyor sections, the opposing conveyor sections include: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; and indicia configured to provide the picker goods transfer instructions for transferring one or more goods from a container on the infeed conveyor to the autonomous mobile robot.

A breakpack pick station is provided for an automated storage and retrieval system. The breakpack pick station includes: a container conveyance comprising a common infeed conveyor section and a common outfeed conveyor section being coupled to each other by opposing conveyor sections, the opposing conveyor sections forming respective container travel loops between the common infeed conveyor section and the common outfeed conveyor section; and a tandem pick station, where each pick station of the tandem pick station is disposed along a respective container travel loop and each pick station of the tandem pick station forms a goods transfer interface to effect breakpack goods transfer between the containers transported by the container conveyance and autonomous goods transport vehicles.

The breakpack pick station may include one or more of the following, employed individually, in any combination with each other, and/or in any combination with the features described above: the common infeed conveyor and the common outfeed conveyor are stacked one above the other where the opposing conveyor sections include: two divergent conveyor sections diverging from the common infeed conveyor section; and two convergent conveyor sections converging into the common outfeed conveyor section, each convergent conveyor section being coupled to a respective divergent conveyor section so as to form the respective container travel loop with the common outfeed conveyor section and the common infeed conveyor section; indicia may be provided and are configured to provide an operator of each pick station of the tandem pick station goods transfer instructions for transferring one or more goods from a container on the container conveyance to autonomous goods transport vehicle; the container conveyance comprises one or more of a belt conveyor, a gravity roller conveyor, a powered roller conveyor, chain conveyor, and a ball transfer conveyor; the goods transfer interface includes at least one autonomous goods transport vehicle interface, each pick station of the tandem pick station being disposed between the at least one autonomous goods transport vehicle interface and the respective container travel loop; the at least one autonomous goods transport vehicle interface comprises two side-by-side autonomous goods transport vehicle interfaces for each pick station; and each autonomous goods transport vehicle interface comprises an autonomous goods transport vehicle travel loop.

An automated storage and retrieval system is provided and includes: a storage structure comprising autonomous container transport vehicles; and a breakpack module, where the autonomous container transport vehicles are configured to transport containers to and from the breakpack module. The breakpack module includes: a container conveyance configured to receive containers from the autonomous container transport vehicles, the container conveyance comprising a common infeed conveyor section and a common outfeed conveyor section being coupled to each other by opposing conveyor sections, the opposing conveyor sections forming respective container travel loops between the common infeed conveyor section and the common outfeed conveyor section, and a tandem pick station, where each pick station of the tandem pick station is disposed along a respective container travel loop and each pick station of the tandem pick station forms a goods transfer interface to effect breakpack goods transfer between the containers transported by the container conveyance and autonomous goods transport vehicles,.

The automated storage and retrieval system may include one or more of the following, employed individually, in any combination with each other, and/or in any combination with the features described above: the storage structure is a multilevel storage structure where more than one level of the storage structure includes a respective breakpack module; the autonomous goods transport vehicle is configured to transfer goods from the tandem pick station to order containers at a container interface, the autonomous container transport vehicles being configured to transfer the order containers to and from the container interface; the common infeed conveyor and the common outfeed conveyor are stacked one above the other; the opposing conveyor sections include: two divergent conveyor sections diverging from the common infeed conveyor section; and two convergent conveyor sections converging into the common outfeed conveyor section, each convergent conveyor section being coupled to a respective divergent conveyor section so as to form the respective container travel loop with the common outfeed conveyor section and the common infeed conveyor section; indicia may be provided and are configured to provide an operator of each pick station of the tandem pick station goods transfer instructions for transferring one or more goods from a container on the container conveyance to autonomous goods transport vehicle; the container conveyance comprises one or more of a belt conveyor, a gravity roller conveyor, a powered roller conveyor, chain conveyor, and a ball transfer conveyor; the goods transfer interface includes at least an autonomous goods transport vehicle interface, each pick station of the tandem pick station being disposed between the at least one autonomous goods transport vehicle interface and the respective container travel loop; the at least one autonomous goods transport vehicle interface comprises two side-by-side autonomous goods transport vehicle interfaces for each pick station; and each autonomous goods transport vehicle interface comprises an autonomous goods transport vehicle travel loop.

A method is provided for transferring breakpack goods at a breakpack pick station in an automated storage and retrieval system. The method includes: providing a breakpack pick station having: a container conveyance comprising a common infeed conveyor section and a common outfeed conveyor section being coupled to each other by opposing conveyor sections, the opposing conveyor sections forming respective container travel loops between the common infeed conveyor section and the common outfeed conveyor section, and a tandem pick station, where each pick station of the tandem pick station is disposed along a respective container travel loop and each pick station of the tandem pick station forms a goods transfer interface; and effecting, at the goods transfer interface, breakpack goods transfer between the containers transported by the container conveyance and autonomous goods transport vehicles.

The method may include one or more of the following, employed individually, in any combination with each other, and/or in any combination with the features described above: the common infeed conveyor and the common outfeed conveyor are stacked one above the other; the opposing conveyor sections include: two divergent conveyor sections diverging from the common infeed conveyor section; and two convergent conveyor sections converging into the common outfeed conveyor section, each convergent conveyor section being coupled to a respective divergent conveyor section so as to form the respective container travel loop with the common outfeed conveyor section and the common infeed conveyor section; providing an operator of each pick station of the tandem pick station goods transfer instructions for transferring one or more goods from a container on the container conveyance to autonomous goods transport vehicle, the instruction being presented through indicia of the breakpack pick station; the container conveyance comprises one or more of a belt conveyor, a gravity roller conveyor, a powered roller conveyor, chain conveyor, and a ball transfer conveyor; the goods transfer interface includes at least one autonomous goods transport vehicle interface, each pick station of the tandem pick station being disposed between the at least one autonomous goods transport vehicle interface and the respective container travel loop; the at least one autonomous goods transport vehicle interface comprises two side-by-side autonomous goods transport vehicle interfaces for each pick station; and each autonomous goods transport vehicle interface comprises an autonomous goods transport vehicle travel loop.

An automated storage and retrieval system is provided. The automated storage and retrieval system includes: at least one autonomous goods transport vehicle; a pick station configured to effect breakpack goods transfer between containers disposed at the pick station and the at least one autonomous goods transport vehicle, the pick station having an autonomous vehicle interface; a transfer deck adjacent the autonomous vehicle interface, the transfer deck has a first travel loop formed by a first inbound vehicle travel lane and a first outbound vehicle travel lane and a second travel loop formed by a second inbound vehicle travel lane and a second outbound vehicle travel lane, where the at least one autonomous goods transport vehicle traverses the transfer deck along the first travel loop and second travel loop for breakpack goods transfer to the at least one autonomous goods transport vehicle at the autonomous vehicle interface; and a barrier disposed between the pick station and each of the first inbound vehicle travel lane and the second inbound vehicle travel lane, the barrier being configured substantially prevent egress of the at least one autonomous goods transport vehicle from a respective one of the first inbound vehicle travel lane and the second inbound vehicle travel lane to the pick station.

The automated storage and retrieval system may include one or more of the following, employed individually, in any combination with each other, and/or in any combination with the features described above: the at least one autonomous goods transport vehicle is configured to depart the autonomous vehicle interface, along the first outbound vehicle travel lane or the second outbound vehicle travel lane, at a high speed with a maximum acceleration of the at least one autonomous goods transport vehicle and a time optimal trajectory; the pick station comprises one or more sensors configured to confirm to a controller of the automated storage and retrieval system that a fast depart condition exists so as to effect, with the controller, departure of the at least one autonomous goods transport vehicle from the autonomous vehicle interface at the high speed; the at least one autonomous goods transport vehicle is configured to approach the pick station, along the first inbound vehicle travel lane or the second inbound vehicle travel lane, at a high speed; the pick station comprises a tandem pick station having: a container conveyance comprising a common infeed conveyor section and a common outfeed conveyor section being coupled to each other by opposing conveyor sections, the opposing conveyor sections forming respective container travel loops between the common infeed conveyor section and the common outfeed conveyor section, and each pick station of the tandem pick station is disposed along a respective container travel loop and each pick station of the tandem pick station forms a goods transfer interface to effect breakpack goods transfer between the containers transported by the container conveyance and the at least one autonomous goods transport vehicle; the common infeed conveyor and the common outfeed conveyor are stacked one above the other; the opposing conveyor sections comprise: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; indicia configured to provide an operator of each pick station of the tandem pick station goods transfer instructions for transferring one or more goods from a container on the container conveyance to autonomous goods transport vehicle; the container conveyance comprises one or more of a belt conveyor, a gravity roller conveyor, a powered roller conveyor, chain conveyor, and a ball transfer conveyor; the goods transfer interface of a respective pick station includes a respective autonomous vehicle interface, the respective pick station being disposed between the respective autonomous vehicle interface and the respective container travel loop; and the respective autonomous vehicle interface comprises two side-by-side autonomous vehicle interfaces, each of the two side-by-side autonomous vehicle interfaces corresponding to a respective one of the first travel loop and the second travel loop.

A method is provided for transferring breakpack goods at a breakpack pick station in an automated storage and retrieval system. The method includes: providing an automated storage and retrieval system comprising: at least one autonomous goods transport vehicle; a pick station configured to effect breakpack goods transfer between containers disposed at the pick station and the at least one autonomous goods transport vehicle, the pick station having an autonomous vehicle interface; and a transfer deck adjacent the autonomous vehicle interface, the transfer deck has a first travel loop formed by a first inbound vehicle travel lane and a first outbound vehicle travel lane and a second travel loop formed by a second inbound vehicle travel lane and a second outbound vehicle travel lane, where the at least one autonomous goods transport vehicle traverses the transfer deck along the first travel loop and second travel loop for breakpack goods transfer to the at least one autonomous goods transport vehicle at the autonomous vehicle interface. The method further includes substantially preventing egress of the at least one autonomous goods transport vehicle, from a respective one of the first inbound vehicle travel lane and the second inbound vehicle travel lane to the pick station, with a barrier disposed between the pick station and each of the first inbound vehicle travel lane and the second inbound vehicle travel lane.

The method may include one or more of the following, employed individually, in any combination with each other, and/or in any combination with the features described above: the at least one autonomous goods transport vehicle departs the autonomous vehicle interface, along the first outbound vehicle travel lane or the second outbound vehicle travel lane, at a high speed with a maximum acceleration of the at least one autonomous goods transport vehicle and a time optimal trajectory; the pick station comprises one or more sensors, the method further comprises confirming, with the one or more sensors, to a controller of the automated storage and retrieval system that a fast depart condition exists so as to effect, with the controller, departure of the at least one autonomous goods transport vehicle from the autonomous vehicle interface at the high speed; the at least one autonomous goods transport vehicle approaches the pick station, along the first inbound vehicle travel lane or the second inbound vehicle travel lane, at a high speed; the pick station comprises a tandem pick station having: a container conveyance comprising a common infeed conveyor section and a common outfeed conveyor section being coupled to each other by opposing conveyor sections, the opposing conveyor sections forming respective container travel loops between the common infeed conveyor section and the common outfeed conveyor section, and each pick station of the tandem pick station is disposed along a respective container travel loop and each pick station of the tandem pick station forms a goods transfer interface to effect breakpack goods transfer between the containers transported by the container conveyance and the at least one autonomous goods transport vehicle; the common infeed conveyor and the common outfeed conveyor are stacked one above the other; the opposing conveyor sections comprise: two divergent conveyor sections diverging from the common infeed conveyor section, and two convergent conveyor sections converging into the common outfeed conveyor section, each convergent conveyor section being coupled to a respective divergent conveyor section so as to form the respective container travel loop with the common outfeed conveyor section and the common infeed conveyor section; providing, with indicia, an operator of each pick station of the tandem pick station goods transfer instructions for transferring one or more goods from a container on the container conveyance to autonomous goods transport vehicle; the container conveyance comprises one or more of a belt conveyor, a gravity roller conveyor, a powered roller conveyor, chain conveyor, and a ball transfer conveyor; the goods transfer interface of a respective pick station includes a respective autonomous vehicle interface, the respective pick station being disposed between the respective autonomous vehicle interface and the respective container travel loop; and the respective autonomous vehicle interface comprises two side-by-side autonomous vehicle interfaces, each of the two side-by-side autonomous vehicle interfaces corresponding to a respective one of the first travel loop and the second travel loop.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. A retail store order fill station for removing at least one good from a storage container of a set of goods, and placement of the at least one good in an order container, the retail store order fill station comprising:
a frame that forms more than one order fill load ports, each of which has a different respective load opening facing a deck of an asynchronous transport system, where autonomous mobile robots autonomously traverse the deck so as to form an inbound lane and an outbound lane along which the autonomous mobile robots respectively arrive to and depart from each load opening, wherein the load opening of each respective order fill load port is separate and distinct from each other order fill load port; and
a side connected to the frame, the side being disposed at an angle with respect to the load opening of each order fill load port, and has a container input interface configured for communicating with an infeed synchronous transport system or conveyor in feeding the storage container, with the set of goods, to the retail order fill station, wherein the container input interface includes at least one of a movable bed and static platform, posed adjacent the respective load opening of each order fill load port so that a picker of the at least one good, picked from the storage container in fed via the container input interface addresses the respective load opening of each order fill load port with substantially one step; and
wherein each respective load opening is arranged with respect to the deck so that each respective load opening has at least a corresponding outbound lane, and the load opening is sized and shaped so that the picker addressing the load opening accesses the autonomous mobile robots, through the addressed load opening, disposed on and aligned with the corresponding outbound lane.

2. The retail store order fill station of claim 1, wherein the respective load opening is sized and shaped so that the autonomous mobile robots disposed on the corresponding outbound lane are accessed via the load opening addressed by the picker.

3. The retail store order fill station of claim 1, wherein the load opening is arranged so as to complement access to the autonomous mobile robots through the load opening of at least one of a human and robot picker.

4. The retail store order fill station of claim 1, further comprising a container output configured for communicating with an outfeed synchronous transport system or conveyor to outfeed one or more of storage containers holding a remaining set of goods not picked by the picker and empty storage containers.

5. The retail store order fill station of claim 1, wherein the movable bed comprises one or more of a belt conveyor, a gravity roller conveyor, a powered roller conveyor, a chain conveyor, and a ball transfer conveyor.

6. The retail order fill station of claim 1, wherein the at least one of the movable bed and static platform comprise an edge proximate the picker and substantially level with a level of the deck.

7. The retail order fill station of claim 1, further comprising an indication system configured to identify the addressed load opening for a pick/place operation by the picker.

8. A distribution center or breakpack transport system for filling at least one ordered good, the distribution center or breakpack transport system comprising:
an asynchronous transport system having a deck with autonomous mobile robots autonomously traversing the deck, and
a breakpack order fill station connected to the deck, the breakpack order fill station having:
a frame that forms more than one order fill load ports, each of which has a different respective load opening facing the deck of the asynchronous transport system, the autonomous mobile robots traverse the deck so as to form an inbound lane and an outbound lane along which the autonomous mobile robots respectively arrive to and depart from each load opening, wherein the load opening of each respective order fill load port is separate and distinct from each other order fill load port; and
a side connected to the frame, the side being disposed at an angle with respect to the load opening of each order fill load port, and has a container input interface configured for communicating with an infeed synchronous transport system or conveyor in feeding a storage container, holding a set of goods, to the breakpack order fill station, wherein the container input interface includes at least one of a movable bed and static platform, posed adjacent the respective load opening of each order fill load port so that a picker of the at least one ordered good, picked from the storage container in fed via the container input interface addresses the respective load opening of each order fill load port with substantially one step; and
wherein each respective load opening is arranged with respect to the deck so that each respective load opening has at least a corresponding outbound lane, and the load opening is sized and shaped so that the picker addressing the load opening accesses the autonomous mobile robots, so as to load the at least one ordered good onto one of the autonomous mobile robots, through the addressed load opening, that is disposed on and aligned with the corresponding outbound lane.

9. The distribution center or breakpack transport system of claim 8, wherein the one of the autonomous mobile robots loaded with the at least one ordered good is arranged so as to traverse the deck and transport the at least one ordered good to an order container separate and distinct from the storage container.

10. The distribution center or breakpack transport system of claim 8, wherein the loaded autonomous mobile robot departs the respective load opening through which the autonomous mobile robot was loaded along the corresponding outbound lane.

11. The distribution center or breakpack transport system of claim 8, wherein the corresponding outbound lane and inbound lane for the respective load opening are on a common level.

12. The distribution center or breakpack transport system of claim 8, wherein the respective load opening is sized and shaped so that the bot disposed on the corresponding outbound lane is accessed via the load opening addressed by the picker.

13. The distribution center or breakpack transport system of claim 8, wherein the load opening is arranged so as to complement access to the bot through the load opening of at least one of a human and robot picker.

14. The distribution center or breakpack transport system of claim 8, further comprising a container output configured for communicating with an outfeed synchronous transport system or conveyor to outfeed one or more of storage containers holding a remaining set of goods not picked by the picker and empty storage containers.

15. The distribution center or breakpack transport system of claim 1, wherein the movable bed comprises one or more of a belt conveyor, a gravity roller conveyor, a powered roller conveyor, a chain conveyor, and a ball transfer conveyor.

16. A method, in a retail store order fill station, for removing at least one good from a storage container of a set of goods, and placement of the at least one good in an order container, the method comprising:
providing the retail store order fill station, where the retail store order fill station comprises:
a frame that forms more than one order fill load ports, each of which has a different respective load opening facing a deck of an asynchronous transport system, where autonomous mobile robots autonomously traverse the deck so as to form an inbound lane and an outbound lane along which the autonomous mobile robots respectively arrive to and depart from each load opening, wherein the load opening of each respective order fill load port is separate and distinct from each other order fill load port; and
a side connected to the frame, the side being disposed at an angle with respect to the load opening of each order fill load port, and has a container input interface configured for communicating with an infeed synchronous transport system or conveyor in feeding the storage container, with the set of goods, to the retail order fill station, wherein the container input interface includes at least one of a movable bed and static platform, posed adjacent the respective load opening of each order fill load port; and
picking, with a picker, the at least one good, picked from the storage container in fed via the container input interface addresses the respective load opening of each order fill load port with substantially one step; and
wherein each respective load opening is arranged with respect to the deck so that each respective load opening has at least a corresponding outbound lane, and the load opening is sized and shaped so that the picker addressing the load opening accesses the autonomous mobile robots, through the addressed load opening, disposed on and aligned with the corresponding outbound lane.

17. The method of claim 16, wherein the respective load opening is sized and shaped so that the bot disposed on the corresponding outbound lane is accessed via the load opening addressed by the picker.

18. The method of claim 16, wherein the load opening is arranged so as to complement access to the bot through the load opening of at least one of a human and robot picker.

19. The method of claim 16, further comprising a container output configured for communicating with an outfeed synchronous transport system or conveyor to outfeed one or more of storage containers holding a remaining set of goods not picked by the picker and empty storage containers.

20. The method of claim 16, wherein the movable bed comprises one or more of a belt conveyor, a gravity roller conveyor, a powered roller conveyor, a chain conveyor, and a ball transfer conveyor.
